(19) United States
(12) Patent Application Publication
(10) Pub. No.: US 2009/0129116 A1
(43) Pub. Date: May 21, 2009

(54) LIGHT GUIDE PLATE, SURFACE LIGHT SOURCE DEVICE, AND LIQUID CRYSTAL DISPLAY DEVICE

(75) Inventors: Kiman Kim, Tsukuba-shi (JP); Masaaki Kubota, Tsukuba-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 12/269,944

(22) Filed: Nov. 13, 2008

(30) Foreign Application Priority Data
Nov. 15, 2007 (JP) P2007-296977

(51) Int. Cl. G02F 1/13357; G02B 27/44; F21V 8/00

(52) U.S. Cl. 362/606; 359/569

(57) ABSTRACT

The present invention provides a light guide plate which can process in polarization separation, and emit a light in a desirable direction, a surface light source device, and a liquid crystal display device. A light guide plate 30 includes a light guide plate main body 31 including a first surface 31a on which a light 100 output from a light source section 20 is made incident, a second surface 31b adjacent to the first surface, a third surface 31d which faces the first surface, and is adjacent to the second surface, and a fourth surface which faces the second surface, and is adjacent to the third surface, and a diffraction grating section 32 arranged on the second surface 31b wherein; the diffraction grating section 32 is configured in such a way that a plurality of gratings 33 consisting of a dielectric is arranged in parallel at an interval Λ along a predetermined direction facing from the first surface to the third surface, wherein; when a wavelength of a visible region possessed by a light 100 is set to be λ, the interval Λ satisfies 1≧Λ/λ≧0.5, and when a refractive index of the light guide plate main body 31 is set to be nₛ, and a refractive index of the grating 33 is set to be n_{g}, the refractive index n_{g} satisfies n_{g}-nₛ≧0.15.

### BACKGROUND OF THE INVENTION

1. Field of the Invention

The present invention relates to a light guide plate, a surface light source device, and a liquid crystal display device.

2. Related Background of the Invention

As a liquid crystal display device such as a liquid crystal display or the like, a configuration, in which a liquid crystal display section formed by arranging a pair of polarizing plates in both of the upper and lower surfaces of liquid crystal display element such as a liquid crystal cell or the like, is provided, furthermore, a surface light source device used for a backlight is arranged on a rear surface side (lower side) of the liquid crystal display section is known. In most liquid crystal display devices, especially, the liquid crystal display device utilized for a mobile device such as a laptop personal computer or the like, an edge light type is adopted as the surface light source device from a point of view such as a purpose of being made thin or the like.

The surface light source device of the edge light type includes a plate-like light guide plate that makes it possible to propagate light, and a light source arranged on a side of one side surface of the light guide plate, furthermore, emits the light which is output from a light source, and introduced inside the light guide plate via the above-described one side surface, additionally, propagated by total reflection by being introduced inside the light guide plate as a surface beam from a top surface (a surface of liquid crystal panel side) of the light guide plate. Furthermore, a light guide plate, which is equipped with a diffraction grating section for extracting the light propagated inside the light guide plate to the outside of the light guide plate, is known.

As the light guide plate equipped with the diffraction grating section, there is a so called “Holographic” light guide plate as described in patent document 1. In this light guide plate, the light propagated inside the light guide plate is emitted outside by a diffraction of the diffraction grating section by forming the diffraction grating section in the light guide plate. In the Holographic light guide plate, an interval of the diffraction grating section is enlarged sufficiently for a diffraction light of higher order to be generated. In this way, in an interval in which the diffraction light of higher order is generated, the light can be emitted at a desired angle to the liquid crystal display element side since an emission angle of the light propagated inside the light guide plate can be controlled by adjusting the interval.

Furthermore, as another light guide plate using the diffraction grating section, for example, as described in the patent document 2, there is a light guide plate utilizing a diffraction grating section known as so-called “wire grid.” The diffraction grating section functioning as a wire grid like this is configured by arranging metal wires in parallel at an interval sufficiently small compared with a wavelength, and has a polarization separating function. Therefore, a light of a desired polarization component can be emitted by processing in polarization separation the light propagated inside the light guide plate. Accordingly, without using a reflection polarizing plate represented by, for example, DBEF (Dual Brightness Enhancement Film) manufactured by 3M Corporation, a light absorbed to a lower layer polarizing plate of the liquid crystal display section is recycled, thereby, utilization efficiency of the backlight can be improved.
Patent Document 1: US Patent Application Laid-Open No. 2004/0246743
Patent Document 2: US Patent Application Laid-Open No. 2003/0210369

### SUMMARY OF THE INVENTION

As described above, in a Holographic light guide plate described in patent document 1, light can be emitted at a desired angle to the liquid crystal display section side by controlling emission angle from a diffraction grating section. However, a polarization state of the light emitted from the light guide plate is equivalent to a polarization state of the light propagated inside the light guide plate, normally, since the light introduced into the light guide plate is stated in non-polarization, the light emitted by the diffraction grating section from the Holographic light guide plate is also stated in the non-polarization. Therefore, when using the Holographic light guide plate, for recycling the light absorbed by a lower layer polarizing plate of a liquid crystal display element, a reflection polarizing plate (for example, DBEF manufactured by 3M Corporation or the like) returning unnecessary polarization to the light guide plate side by being separated from emission light is required to be provided between the light guide plate and the liquid crystal display section.

On the other hand, in the case of the light guide plate equipped with the diffraction grating section as the wire grid described in patent document 2, the light processed in polarization separation is emitted from the light guide plate. Therefore, as with the case that the light guide plate described in patent document 1 is adopted, the reflection polarizing plate is not necessary. However, in the diffraction grating section as the wire grid described in patent document 2, an interval of the diffraction grating section is sufficiently small compared with a wavelength for giving polarization separation function. As a result, a diffraction light of 0 order is mainly generated. Accordingly, emission angle cannot be controlled. Therefore, another structure for converging by directing the light emitted from the light guide plate to the liquid crystal display section is necessary in a space between the liquid crystal display section and the light guide plate.

Accordingly, the present invention aims to provide a light guide plate in which the polarization separation is possible, and the light can be emitted in a desired direction, a surface light source device, and a liquid crystal display device.

The light guide plate according to the present invention, which includes a light guide plate main body having a first surface on which a light output from a light source section is made incident, a second surface adjacent to the first surface, a third surface which faces the first surface, and is adjacent to the second surface, and a fourth surface which faces the second surface, and is adjacent to the third surface, and the diffraction grating section provided on the second surface, wherein the diffraction grating section is configured by arranging a plurality of gratings consisting of a dielectric in parallel at an interval Λ along a predetermined direction facing from the first surface to the third surface, that when a wavelength of a visible region possessed by the above-described light is set to be λ, the interval Λ satisfies

1≧Λ/λ≧0.5,

and that when a refractive index of the light guide plate main body is set to be nₛ, and a refractive index of the grating is set to be n_{g}, the refractive index n_{g} satisfies

n_{g}-nₛ≧0.15.

In this configuration, the light output from the light source section is made incident into the light guide plate main body from the first surface. Furthermore, the light made incident into the light guide plate propagates inside the light guide plate main body toward the third surface. At this time, since the diffraction grating section is arranged on the second surface, the light propagating inside the light guide plate main body can be extracted from second surface side. Furthermore, since the interval Λ of the diffraction grating section satisfies the above-described relationship with respect to the wavelength λ possessed by the light, the emission angle from the light guide plate can be controlled. Additionally, since the refractive index of the grating constituting the diffraction grating section, and the refractive index of the light guide plate main body satisfy the above-described relationship, the polarization separation can be processed by the diffraction grating section, therefore, the light, in which S polarization component is predominant, can be emitted from the light guide plate. Accordingly, when applying the above-described light guide plate, for example, to the liquid crystal display device, an element for aligning a propagation direction of the emission light, or an element for recycling unnecessary polarization from the emission light is not required to be provided. As a result, the liquid crystal display device can be downsized and made thin.

In the light guide plate according to the present invention, it is desirable that the diffraction grating section has a plurality of diffraction regions different in an extraction efficiency of the light from the diffraction grating section along a predetermined direction, and it is desirable that the extraction efficiencies of the plurality of diffraction regions increase at the third surface side in the predetermined direction.

In the above-described light guide plate, while the light made incident from the first surface side of the light guide plate main body is propagated to the third surface side, the light of the S polarization component is extracted from the second surface side by the diffraction grating section arranged on the second surface. Therefore, in the light propagated to the third surface from the first surface side, P polarization component increases in ratio as it approaches the third surface. As described above, when the diffraction grating section has a plurality of diffraction regions, and the extraction efficiency of the diffraction region becomes higher as the region approaches the third surface side, the S polarization component of the light can be efficiently extracted in the third surface side. Accordingly, even when the P polarization component increases in ratio as the light propagates to the third surface side, the light can be extracted substantially uniformly from the second surface side.

Furthermore, in the light guide plate according to the present invention, it is desirable that a polarization converting element which is arranged on the third surface of the light guide plate main body, and reflects the light to the first surface side by converting a polarization state of the above-described light is further provided.

In this configuration, the polarization state of the light reaching the third surface by being made incident from the first surface is converted by the polarization converting element, and returned inside the light guide plate main body again from the third surface. In the above-described light guide plate, while the light made incident from the first surface of the light guide plate main body is propagated to the third surface side, the light of the S polarization component is extracted from the second surface side by the diffraction grating section arranged on the second surface. Therefore, the P polarization component increases in ratio as the light propagating from the first surface side to the third surface approaches the third surface. Accordingly, since the light high in a ratio of the P polarization component is made incident to the polarization converting element, the light high in a ratio of S polarization component is returned from the polarization converting element to the light guide plate main body. As a result, the light can be reliably extracted from the third surface side, and the light can be emitted substantially uniformly from the second surface.

Furthermore, in the light guide plate according to the present invention, it is desirable that a reflector reflecting the above-described light is arranged on the fourth surface of the light guide plate main body.

When the above-described light is made incident to the diffraction grating section, one part of it, as described above, is extracted from the second surface side to the outside of the light guide plate main body, on the other hand, the other part is diffracted inside the light guide plate main body. At this time, in a diffraction light of higher order among the light diffracted to the light guide plate main body, the diffraction light of higher order made incident to the fourth surface at an angle close to roughly perpendicular direction is also included. In the light guide plate equipped with the above-described reflector, since the reflector is arranged in the fourth surface, the diffraction light made incident to the fourth surface at the angle close to roughly perpendicular direction is reflected to the second surface side, and can be emitted to the outside of the light guide plate main body as a diffraction light of 0 order from the diffraction grating section. Furthermore, in the light guide plate in which the refractive index of grating satisfies the above-described relationship with respect to the refractive index of the light guide plate main body, since the diffraction light of higher order by the diffraction grating section increases in a ratio of the S polarization component, the light emitted from the second surface side to the outside of the light guide plate by being reflected by the reflector is also emitted as the light in which the S polarization component is predominant.

The surface light source device according to the present invention, which includes (A) a light source section outputs the light including a visible region, (B) a light guide plate main body including a first surface on which the light output from the light source section is made incident, a second surface adjacent to the first surface, a third surface which faces the first surface, and is adjacent to the second surface, and a fourth surface which faces the second surface, and is adjacent to the third surface, and a light guide plate having a diffraction grating section arranged on the second surface, wherein the diffraction grating section is configured by arranging in parallel a plurality of gratings consisting of a dielectric at an interval Λ along a predetermined direction facing from the first surface to the third surface, that when a wavelength of the visible region possessed by the above-described light is set to be λ, the interval Λ satisfies

1≧Λ/λ≧0.5,

and that when the refractive index of the light guide plate main body is set to be nₛ, and the refractive index of the grating is set to be n_{g}, the refractive index n_{g} satisfies

n_{g}-nₛ≧0.15.

In this configuration, the light output from the light source section is made incident inside the light guide plate main body from the first surface. Furthermore, the light made incident inside the light guide plate propagates toward the third surface in the light guide plate main body. At this time, since the diffraction grating section is arranged on the second surface, the light propagating inside the light guide plate main body can be extracted from the second surface side. Additionally, since the interval Λ of the diffraction grating section satisfies the above-described relationship with respect to the wavelength λ possessed by the light, emission angle from the light guide plate can be controlled. Furthermore, since the refractive index of the grating constituting the diffraction grating section, and the refractive index of the light guide plate main body satisfy the above-described relationship, the light can be processed in polarization separation by the diffraction grating section, and the light, in which the S polarization component is predominant, can be emitted from the light guide plate. Therefore, for example, when the above-described surface light source device is applied to the liquid crystal display device, an element for aligning a propagation direction of the emission light, or an element for recycling unnecessary polarization from the emission light is not required to be provided. As a result, the liquid crystal display device can be downsized, and made thin.

In the surface light source device according to the present invention, it is desirable that the diffraction grating section has a plurality of diffraction regions different in an extraction efficiency of the light from the diffraction grating section, and it is desirable that the extraction efficiencies of a plurality of diffraction regions become higher at the third surface side in the predetermined direction.

In the light guide plate provided by the surface light source device, while the light made incident from the first surface of the light guide plate main body is propagated to the third surface side, the light of the S polarization component is extracted from the second surface side by the diffraction grating section arranged on the second surface. Therefore, as the light propagating to the third surface from the first surface side approaches the third surface, the P polarization component increases in ratio. As described above, when the diffraction grating section has the plurality of diffraction regions, and the extraction efficiency of the diffraction region increases as the region approaches the third surface side, the S polarization component of the light can be efficiently extracted in the third surface side. Accordingly, even when the P polarization component becomes higher in ratio as the light propagates to the third surface side, the light can be extracted substantially uniformly from the second surface side.

Furthermore, in the surface light source device according to the present invention, it is desirable that the polarization converting element, which is arranged on a side of the third surface, and reflects the light to the first surface side by converting the polarization state of the light output from the third surface, is further provided.

In this configuration, the light is returned again inside the light guide plate main body from the third surface in such a way that the polarization state of the light reaching the third surface by being made incident from the first surface is converted by the polarization converting element. In the above-described light guide plate, while the light made incident from the first surface of the light guide plate main body is propagated to the third surface side, the light of S polarization component is extracted from the second surface side by the diffraction grating section arranged on the second surface. Therefore, as the light propagating to the third surface from the first surface side approaches the third surface, the P polarization component increases in ratio. Accordingly, since the light high in a ratio of the P polarization component is made incident to the polarization converting element, the light high in a ratio of the S polarization component is returned to the light guide plate main body from the polarization converting element. As a result, the light can be reliably extracted from the third surface side, and the light can be emitted substantially uniformly from the second surface.

Furthermore, in the surface light source device according to the present invention, it is desirable that a reflector, which is arranged on a side opposite to the second surface side with respect to the fourth surface, and reflects the light to the second surface side, is further provided.

When the above-described light is made incident to the diffraction grating section, one part of it, as described above, is extracted to the outside of the light guide plate main body from the second surface side, on the other hand, the other part is diffracted inside the light guide plate main body. At this time, in the diffraction light of higher order among the light diffracted inside the light guide plate main body, the diffraction light of higher order made incident to the fourth surface at an angle close to the roughly perpendicular direction is included. In the surface light source device equipped with the above-described reflector, the diffraction light propagated at an angle close to the roughly perpendicular direction to the fourth surface is reflected to the second surface side by the reflector, and emitted to the outside of the light guide plate main body as a diffraction light of 0 order from the diffraction grating section. Furthermore, in the light guide plate in which the refractive index of the grating satisfies the above-described relationship with respect to the refractive index of the light guide plate main body, since the diffraction light of higher order by the diffraction grating section increases in a ratio of the S polarization component, the light, which is reflected by the reflector, and emitted to the outside of the light guide plate from the second surface side, is also emitted as the light in which the S polarization component is predominant.

Additionally, a transmission image display device according to the present invention, which includes (1) a surface light source device, and (2) a liquid crystal display section on which the light output from the surface light source device is made incident, wherein the above-described surface light source device includes (a) a light source section outputting the light including a visible region, (b) a light guide plate main body having a first surface on which the light output from the light source section is made incident, a second surface adjacent to the first surface, a third surface which faces the first surface, and is adjacent to the second surface, and a fourth surface which faces the second surface, and is adjacent to the third surface, and (c) a light guide plate having a diffraction grating section arranged on the second surface, wherein the diffraction grating section is configured by aligning in parallel a plurality of gratings consisting of the dielectric along a predetermined direction facing from the first surface to the third surface, that when the wavelength of the visible region possessed by the above-described light is set to be λ, the interval Λ satisfies

1≧Λ/λ≧0.5

and that when the refractive index of the light guide plate main body is set to be nₛ, and the refractive index of the grating is set to be n_{g}, the refractive index n_{g} satisfies

n_{g}-nₛ≧0.15.

In this configuration, the light output from the light source section possessed by the surface light source device is made incident inside the light guide plate main body from the first surface of the light guide plate main body possessed by the light guide plate. Furthermore, the light made incident inside the light guide plate main body propagates toward the third surface. At this time, since the diffraction grating section is arranged on the second surface, the light propagating inside the light guide plate main body can be extracted from the second surface side. Additionally, since the interval Λ of the diffraction grating section satisfies the above-described relationship with respect to the wavelength λ possessed by the light, the emission angle from the light guide plate can be controlled. Furthermore, the refractive index of the grating constituting the diffraction grating section, and the refractive index of the light guide plate main body satisfy the above-described relationship, the light is processed in polarization separation by the diffraction grating section, and the light, in which the S polarization component is predominant, can be emitted from the light guide plate. Therefore, from the surface light source device, a surface beam, in which the S polarization component is predominant, and the light is converged in a predetermined direction, can be output toward the liquid crystal display element. For that reason, in the liquid crystal display device, an element for aligning the propagation direction by converging output light from the surface light source device, or an element for recycling unnecessary polarization light from the output light is not required to be provided. As a result, the liquid crystal display element can be downsized and made thin.

### BRIEF DESCRIPTION OF THE DRAWINGS

FIG. 1 is a side view of one embodiment of a liquid crystal display device according to the present invention.

FIG. 2 is a side view of a light guide plate shown in FIG. 1.

FIG. 3 is a diagram showing a calculation result of a diffraction efficiency of the diffraction grating section with respect to incident angle θᵢₙ.

FIG. 4 is a diagram showing calculation results of a S/P ratio and total diffraction efficiency when a refraction index n_{g} of a grating possessed by the diffraction grating section is set to be 1.60.

FIG. 5 is a diagram showing the S/P ratio and the total diffraction efficiency when the refraction index n_{g} of the grating possessed by the diffraction grating section is set to be 1.65.

FIG. 6 is a diagram showing the S/P ratio and the total diffraction efficiency when the refraction index n_{g} of the grating possessed by the diffraction grating section is set to be 1.70.

FIG. 7 is a diagram showing the S/P ratio and the total diffraction efficiency when the refraction index n_{g} of the grating possessed by the diffraction grating section is set to be 1.75.

FIG. 8 is a diagram showing the S/P ratio and the total diffraction efficiency when the refraction index n_{g} of the grating possessed by the diffraction grating section is set to be 1.90.

FIG. 9 is a diagram showing the S/P ratio and the total diffraction efficiency when the refraction index n_{g} of the grating possessed by the diffraction grating section is set to be 2.05.

FIG. 10 is a diagram showing the S/P ratio and the total diffraction efficiency when the refraction index n_{g} of the grating possessed by the diffraction grating section is set to be 2.50.

FIG. 11 is a diagram showing the S/P ratio and the total diffraction efficiency when the refraction index n_{g} of the grating possessed by the diffraction grating section is set to be 1.50, for making a comparison.

FIG. 12 is a diagram showing the S/P ratio and the total diffraction efficiency when the refraction index n_{g} of the grating possessed by the diffraction grating section is set to be 1.55, for making a comparison.

FIG. 13 is a diagram showing a calculation result of illumination distribution of emission light from the light guide plate by a light source tracing method.

FIG. 14 is a diagram showing emission angle distribution in the calculation result shown in FIG. 13.

FIG. 15 is a side view schematically showing a configuration of another embodiment of the light guide plate according to the present invention.

FIG. 16 is a side view schematically showing a configuration of still another embodiment of the light guide plate according to the present invention.

FIG. 17 is a pattern view of the light guide plate for explaining the configuration of the diffraction grating section shown in FIG. 16.

### DESCRIPTION OF THE PREFERRED EMBODIMENTS

In the following, embodiments of a light guide plate, a surface light source device, and a liquid crystal display device of the present invention are explained by referring to figures. Furthermore, in an explanation of the figures, the same numerals are attached to the same elements, and overlapping explanation is omitted. Additionally, a dimension ratio of the figure does not always conform with that of the explanation. Furthermore, words indicating direction such as [up], [down] or the like in the present specification are convenient words based on the state shown in the figure.

### First Embodiment

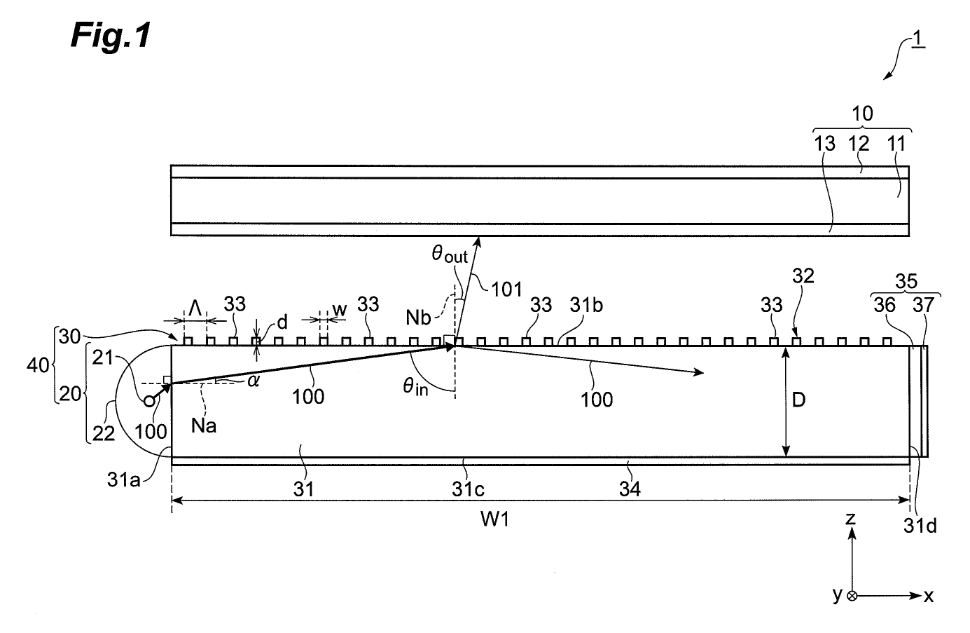

FIG. 1 is a side view schematically showing a configuration of one embodiment of the liquid crystal display device according to the present invention. A liquid crystal display device 1 includes a liquid crystal display element 10, and a surface light source device 40 being one embodiment of the surface light source device according to the present invention, and is preferably applied to a device that can be made mobile such as a laptop computer or the like. In the following explanation, as shown in FIG. 1, an arrangement direction between the surface light source device 40 and the liquid crystal display device 10 can be called the z axis direction, and 2 directions crossing at roughly right angles with the z axis direction can be called the x axis direction and the y axis direction.

The liquid crystal display device 10 is configured by laminating polarizing plates 12, 13 on upper/lower surfaces of a liquid crystal cell 11. In the following explanation, a lamination direction of a polarizing plate 12, the liquid crystal cell 11, and a polarizing plate 13 is set to be the z axis direction, and 2 directions crossing at roughly right angles with the z axis direction are called the x axis direction and the y axis direction as shown in FIG. 1. For the liquid crystal cell 11, and the polarizing plates 12, 13, members used for a transmission image display device such as a conventional liquid crystal display device or the like can be adopted. The liquid crystal cell 11 is illustrated by a well-known liquid crystal cell such as a TFT type, an STN type or the like. Furthermore, the polarizing plates 12, 13 processed as an upper and lower pair are arranged on a state in which their transmission axes mutually cross at right angles, and the transmission axes of these polarizing plates 12, 13 are arranged so that they may be parallel to an orientation direction of a liquid crystal molecule in the liquid crystal cell 11.

The surface light source device 40 is arranged on a rear surface side (lower side) of the liquid crystal display element 10, and supplies backlight to the liquid crystal display element 10. The surface light source device 40 includes a light source section 20, and a light guide plate 30, and is a device of an edge light type in which the light source section 20 is arranged on a side of the light guide plate 30.

The light source section 20 has a light source 21 emitting a light 100 including a light of a visible region. The light source 21 is illustrated by LD (Laser Diode), LED (Light Emitting Device), CCFL (Cold Cathode Fluorescent Lamp) or the like, and if units output the light 100 including a visible light of wavelength 400 nm-700 nm, they are not limited to these examples in particular.

Furthermore, from the point of view of efficiently utilizing the light 100 output from the light source 21, as shown in FIG. 1, it is desirable that the light source section 20 has a reflection member 22. The reflection member 22 is configured by making a plate-like reflection panel in which inner surface is processed to have a mirror-like finish or a white reflection finish curved in the manner of a tube so as to cover the surroundings of the light source 21, and has an aperture at the light guide plate 30 side. In a configuration of this light source section 20, for example, even when utilizing a light source without possessing directivity as with the case of CCFL, the light 100 output from the light source 21 can be output from the aperture to the light guide plate 30 side by being reflected by the reflection member 22.

The light guide plate 30 is arranged on a side of the light source section 20. The light guide plate 30 is configured by including a light guide plate main body 31 that makes it possible to propagate the light 100, a diffraction grating section 32 arranged with respect to the light guide plate main body 31, a reflector 34, and a polarization converting element 35.

As a material of the light guide plate main body 31 is illustrated by a material small in absorption with respect to the light 100, especially, the light of a visible region included in the light 100, for example, acryl, polystyrene, a resin of polycarbonate system or the like, quartz, or oxide tantalum.

The light guide plate main body 31 is a roughly rectangular parallelepiped shape, and includes an incident surface (a first surface) 31a facing the light source 21, an emission surface (a second surface) 31b roughly orthogonal to the incident surface 31a, a rear surface (a fourth surface) 31c which is facing the emission surface 31b, and roughly perpendicular to the incident surface 31a, and a side surface (a third surface) 31d which is facing the incident surface 31a, and roughly perpendicular to the emission surface 31b and the rear surface 31c. Each of the incident surface 31a, the emission surface 31b, the rear surface 31c, and the side surface 31d is flat, respectively. A width W1 of x axis direction of the light guide plate main body 31, that is, a distance between the incident surface 31a and the side surface 31d is 10 mm, and a width W2 (not shown) of y axis direction is also, for example, 10 mm. Furthermore, a thickness D of the light guide plate main body 31, that is, a distance between the rear surface 31c and the emission surface 31b is, for example, 1 mm.

When the light 100 is made incident to the light guide plate main body 31 via the incident surface 31a, since an angle α between the light 100 made incident inside the light guide plate main body 31 from the incident surface 31a, and a normal line Na with respect to the incident surface 31a is smaller than a critical angle, the light 100 is made to propagate inside the light guide plate main body 31 by mainly total reflection.

The diffraction grating section 32 is formed a layered shape, and arranged on the emission surface 31b. The diffraction grating section 32 functions for extracting the light 100 propagated inside the light guide plate main body 31 to the outside of the light guide plate main body 31, and generates an emission light 101 by diffracting one part of an S polarization component among the light 100 toward the liquid crystal display element 10. A detailed configuration of this diffraction grating section 32 is described later.

The reflector (reflecting means) 34 is arranged by almost the entire surface of the rear surface 31c, and the reflector 34, for example, is formed by dielectric multilayer film, and metal thin film deposited by metal or the like.

Furthermore, the polarization converting element 35 is arranged on the side surface 31d, and configured by including a λ/4 plate 36 arranged in order from the side surface 31d side, and a reflector 37. In this configuration, the light 100 emitted from the side surface 31d passes through the λ/24 plate 36, and after being reflected to side surface 31d side (or, incident surface 31a side) by the reflector 37, it is returned inside the light guide plate main body 31 by passing through the λ/4 plate 36 again. In this way, the light 100, which reaches the side surface 31d after being propagated inside the light guide plate main body 31 by being made incident from the incident surface 31a, is returned inside the light guide plate main body 31 in such a way that a polarization state is converted by the polarization converting element 35.

In a configuration of the above-described light guide plate 30, the light 100 output from the light source 20 is made incident inside the light guide plate main body 31 via the incident surface 31a, and propagates toward side surface 31d side inside the light guide plate main body 31, that is, in the x axis direction (predetermined direction). One part of the S polarization component in the light 100 propagating inside the light guide plate main body 31 is extracted from the emission surface 31b side by the diffraction grating section 32 arranged on the emission surface 31b. The light extracted from this emission surface 31b side is made incident to the liquid crystal display element 10 as the emission light 101. On the other hand, the light 100 not extracted to the outside of the light guide plate 30 by the diffraction grating section 32 is returned inside the light guide plate main body 31. At this time, although a part of the light happens to be returned so that it may not satisfy the total reflection condition inside the light guide plate main body 31 by a diffraction by the diffraction grating section 32, the light not satisfying the above-described total reflection condition can be emitted from the emission surface 31b by being reflected to the emission surface 31b side without changing the polarization state in such a way that the reflector 34 is provided in the rear surface 31c.

As described above, in the light guide plate 30, while the light 100 made incident from the incident surface 31a propagates to the side surface 31d side, one part of the S polarization component is extracted to the outside of the light guide plate main body 31 as the emission light 101. Therefore, as the light 100 propagates to the side surface 31d side, the P polarization component in the light 100 increases in ratio. Accordingly, the light 100 high in a ratio of the P polarization component is made incident to the polarization converting element 35 via the side surface 31d. As a result, since the light high in a ratio of the S polarization component is returned to the light guide plate main body 31 from the polarization converting element 35, the emission light 101 is reliably emitted from the emission surface 31b also in the side surface 31d side. Therefore, the emission light 101, in which the S polarization component is predominant, can be emitted substantially uniformly from the emission surface 31b, and a surface beam, in which the S polarization component is predominant, can be output by the surface light source device 40.

Next, the diffraction grating section 32 being one characteristic of the light guide plate 30 is explained in detail.

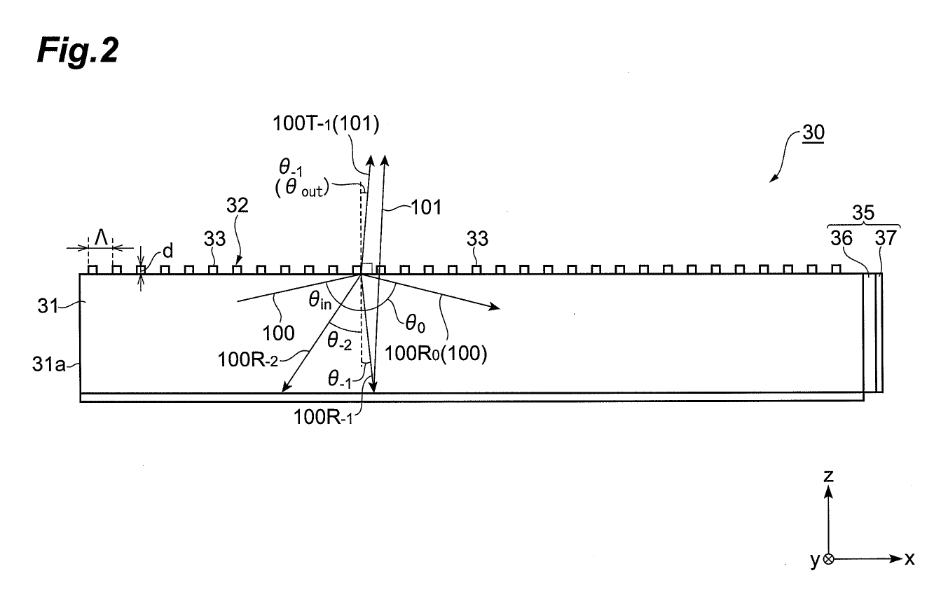

FIG. 2 is a side view of the light guide plate shown in FIG. 1. In FIG. 2, one example of diffraction light by the diffraction grating section 32, when the light 100 is made incident one time to the diffraction grating section 32 arranged on the emission surface 31b of the light guide plate main body 31 in which refraction index is approximately 1.45, is shown. In the following explanation, the diffraction light of m order diffracted to the outside of the light guide plate main body 31, that is, liquid crystal display element 10 side (in FIG. 2, upper side) is called a transmission diffraction light 100Tₘ, and the diffraction light of m order diffracted to a rear surface 31c side of the light guide plate main body 31 is called a reflection diffraction light 100R₋ₘ. Furthermore, the transmission diffraction light 100Tₘ becomes the emission light 101 from the light guide plate 30, and the reflection diffraction light 100R₋ₘ propagates inside the light guide plate main body 31. Although the light propagating inside the light guide plate main body 31 is made to include the light 100, and the reflection diffraction light 100R₋ₘ, since the reflection diffraction light 100R₋ₘ is generated from the light 100, as long as no specific limitation is given, the light propagating inside the light guide plate main body 31 is called the light 100.

The diffraction grating section 32 is a diffraction grating configured by a plurality of gratings 33 arranged at the interval Λ in the x axis direction. The grating 33 is extended in one direction (y axis direction), and a linear body consisting of the dielectric. Although a cross section profile of the grating 33 which intersects at roughly right angles with a longitudinal direction of the grating 33 is illustrated by a square, it can be illustrated by a rectangle. A width w and a height (length in z axis direction) d of the grating 33 are, for example, 65 nm.

The interval Λ of the diffraction grating section 32, when a wavelength within a visible region in the light 100 is set to be λ, satisfies

[Equation 1]

1≧Λ/λ≧0.5 (1)

In other words, the diffraction grating section 32 is configured that the grating 33 is arranged discretely in the x axis direction at the interval Λ satisfying the equation (1). The interval Λ is, for example, 420 nm.

Diffraction of the light having the wavelength λ by the diffraction grating section 32, when a diffraction angle of the diffraction light of m order is set to be φₘ, is represented by

[Equation 2]

n_{g} sin φₘ−nₛ sin θᵢₙ=λ·m/Λ (2)

For example, when the interval Λ is small enough with respect to the wavelength λ, only m=0, that is, a diffraction light of 0 order can exist, however, since the interval Λ satisfies the equation (1), the diffraction grating section 32 has the diffraction light of order greater than 0 order. As a result, as shown in FIG. 1, the transmission diffraction light 100 Tₘ and the reflection diffraction light 100 R₋ₘ are generated toward the outside and the rear surface 31c side of the light guide plate main body 31. As shown in FIG. 2, when a refractive index of the light guide plate main body 31 is approximately 1.45, and the diffraction grating section 32 is formed by a refractive index difference between the grating 33 and air, in a condition of the equation (1), a permitted order of the diffraction light may be ±2 order at most. Among them, since strengths of 1 order reflection diffraction light 100 R₋₁ and −2 order transmission diffraction light 100 R₂ become very small, they are not shown in FIG. 2. Since the light 100 propagating inside the light guide plate main body 31 is made incident at an angle greater than a critical angle to the emission surface 31b, and as described later, a 0 order transmission diffraction light 100 T₀ is rarely generated, it is not shown in FIG. 2. Accordingly, as shown in FIG. 2, major diffraction lights generated when the light 100 is made incident one time to the diffraction grating section 32 which is arranged on the light guide plate main body 31 in which the refractive index is 1.45, and satisfies the equation (1) are a −1 order reflection diffraction light 100 R₋₁, a 0 order reflection diffraction light 100 R₋₀, a −2 order reflection diffraction light 100 R₂, and a −1 order transmission diffraction light 100₋₁. Additionally, the transmission diffraction light 100T₋₁ as a diffraction light toward the outside of the light guide plate main body 31 being the liquid crystal display element 10 side in FIG. 1 becomes the emission light 101 from the light guide plate main body 31, and the reflection diffraction lights 100R₋₀, and 100R₋₂ as the diffraction light inside the light guide plate main body 31 become the light 100 propagating inside the light guide plate main body 31. Furthermore, the reflection diffraction light 100 R₋₁ becomes the emission light 101 by being emitted from the emission surface 31b side after being reflected by the reflector 34.

Since an emission angle θₒᵤₜ of the emission light 101 corresponds to a diffraction angle φₘ, the emission light 101 toward the liquid crystal display element 10 can be generated by adjusting the interval Λ in a range satisfying the equation (2), and the diffraction grating section 32 has an emission angle control function. Furthermore, in the case shown in FIG. 2, the emission angle θₒᵤₜ (or diffraction angle φ₋₁) of the −1 order transmission diffraction light 100T₋₁ can be set in a range of −30° to 30° by referring to a roughly normal line Nb direction of the emission surface 31b, for example, a normal line Nb. Furthermore, since in the reflection diffraction light 100R₋₁, as with the case of the −1 order transmission diffraction light 100T₋₁, the diffraction angle φ₋₁ can be adjusted in a range of, for example, −30° to 30°, the reflection diffraction light 100R₋₁ is reflected by the reflector 34, and made incident roughly perpendicular to the diffraction grating section 32 on the emission surface 31b. As a result, it is emitted in the range of −30° to 30° by referring to the normal line Nb as the 0 order transmission diffraction light 100T₀.

As shown in the equation (1), since the interval Λ is determined with respect to one wavelength λ, for example, when designing the diffraction grating section 32, a difference is generated in the diffraction angle φₘ also according to a difference between the wavelength λ assumed for design and the other wavelength within the visible region, and as a result, a range is generated in the emission angle θₒᵤₜ. However, when belonging within a wavelength range of a visible region, setting can be performed with respect to only one wavelength λ. A wavelength λ for design is illustrated by 470 nm of a blue color system, 555 nm of a green color system, and 640 nm of a red color system. However, from the point of view that a variation range of the emission angle θₒᵤₜ in the visible region is made small, close to 550 nm being a central wavelength of 400 nm-700 nm is desirable, and when selected among wavelengths of the blue color system, the green color system, and the red color system, 555 nm of the green color system is desirable.

Furthermore, when the refractive index of the grating 33 is set to be n_{g}, and the refractive index of the light guide plate main body 31 is set to be nₛ, refractive index difference n_{d}(=n_{g}-nₛ) satisfies

[Equation 3]

n_{d}≧0.15 (3)

In other words, the grating 33 is configured by a dielectric material having the refraction index n_{g} satisfying the equation (3) with respect to the refractive index nₛ possessed by the light guide plate main body 31. For example, when the light guide plate main body 31 is configured by a quartz in which the refractive index is approximately 1.45, the grating 33 can be configured by a dielectric material in which the refractive index is approximately 1.60 or more. As a dielectric material in which the refractive index is 1.60 or more, for example, there is tantalum oxide in which the refractive index is 2.05 or titanium oxide (TᵢO₂) in which the refractive index is 2.5 or the like. When as a material of the grating 33, the tantalum oxide, or the titanium oxide is adopted, for example, as a material of the light guide plate main body 31, acryl in which the refractive index is 1.49 can be also adopted.

Since the diffraction grating section 32 satisfies the equation (3), the S polarization component can be mainly diffracted to the outside of the light guide plate main body 31, therefore, the polarization separation function is available.

Technical content that the diffraction grating section 32 has the polarization separation function by satisfying the equation (3) is concretely explained based on a calculation result of the diffraction efficiency of the light 100 by the diffraction grating section 32. As a calculation model, as shown in FIG. 2, a case that the light 100 is made incident one time to the diffraction grating section 32 at an incident angle θᵢₙ is assumed. Calculation conditions are as follows so that they may satisfy the equation (1) and the equation (3).
A material of the light guide plate main body 31: quartz (refraction index: 1.45)
An interval Λ of the diffraction grating section 32: 420 nm
A material of the grating 33: tantalum oxide (refraction index: 2.05)
A width w of the grating 33: 65 nm
A height d of the grating 33: 65 nm
Wavelength λ: 555 nm
   When the refractive index of the light guide plate main body 31 is 1.45, as described above, for the diffraction light of higher order, the diffraction light of up to ±2 order can be permitted. Furthermore, the 2 order transmission diffraction light 100T₋₂ is not considered because it is rarely generated.

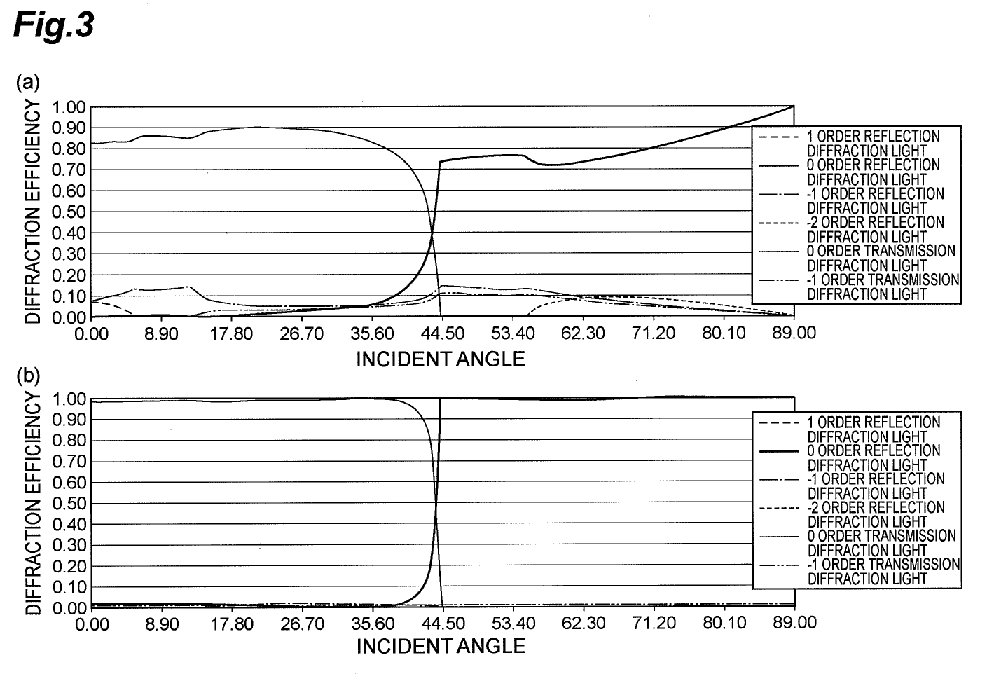

FIG. 3 is a drawing showing a calculation result of diffraction efficiency of the diffraction grating section 32 with respect to the incident angle θᵢₙ, and FIG. 3(a) is a drawing showing a calculation result with respect to the S polarization component, furthermore, FIG. 3(b) is a drawing showing a calculation result with respect to the P polarization component.

In a result shown in FIG. 3, the incident angle θᵢₙ is shown with respect to an angle smaller than total reflection angle, and as shown in FIG. 1, when the light 100 from the light source 21 is made incident inside the light guide plate main body 31 via the incident surface 31a, an angle α formed between the light 100 made incident from the incident surface 31a, and a normal line Na of the incident surface 31a becomes smaller than approximately 43.6° being the total reflection angle. As a result, the incident angle θᵢₙ tends to be between 90°-α and 90°. That is to say, in a result shown in FIG. 3, diffraction property with respect to a incident angle θᵢₙ still greater than approximately 46.4°, that is greater than the critical angle, becomes important.

As shown in FIG. 3(a) and FIG. 3(b), in both of the S polarization component and the P polarization component, the 0 order reflection diffraction light 100R₋₀ is generated at the incident angle θᵢₙ greater than 46.4°, on the other hand, the 0 order transmission diffraction light 100T₀ is rarely generated, therefore, in the light 100, most of the S polarization component and the P polarization component are apparently reflected roughly similar to total reflection. This is obtained by the reason that the diffraction grating section 32 satisfies the equation (1).

On the other hand, with respect to the S polarization component by an influence of the diffraction grating section 32, as shown in FIG. 3(a), the diffraction light of higher order such as the −1 order transmission diffraction light 100T₋₁, the −1 order reflection diffraction light 100R₋₁, or the −2 order reflection diffraction light 100R₋₂ is generated. On the contrary, as shown in FIG. 3(b), with respect to the P polarization component, the −1 order transmission diffraction light 100T₋₁, the −1 order reflection diffraction light 100R₋₁, and the −2 order reflection diffraction light 100R₋₂ are rarely generated. That is, the diffraction property in the diffraction grating section 32 is different between the P polarization component and the S polarization component, and the diffraction grating section 32 apparently acts as the diffraction grating more strongly with respect to the S polarization component than with respect to the P polarization component. As a result, the light of the S polarization component can be mainly emitted from the emission surface 31b side of the light guide plate 30, therefore, the diffraction grating section 32 functions as the polarization separation element.

Next, a relationship between a refractive index difference n_{d} and a polarization separation degree is explained based on a calculation result. In this case also, a case that the light 100 is made incident one time to the diffraction grating section 32 at the incident angle θᵢₙ is implemented in calculation. Among conditions assumed to be calculated, a material and the refractive index nₛ of the light guide plate main body 31, the interval Λ in the diffraction grating section 32, and the wavelength λ of the light 100 are the same as the case of the calculation shown in FIG. 3. In this case, Λ/λ is approximately 0.757, and satisfies the equation (1).

Furthermore, on condition that the light source 21 has a predetermined light distribution property, in other words, directivity, strengths of optical components of 50°, 60°, 70°, and 80° of the incident angle θᵢₙ in the light 100 are assumed to be 3, 16, 14, and 11 (a. u), respectively.

In the calculation, while appropriately changing the width w and the height d, an S/P ratio defined as an index showing the polarization separation degree, and a total diffraction efficiency η are calculated. The S/P ratio and the total diffraction efficiency η are defined as an equation (4), and an equation (5), respectively.

$$\begin{matrix}[ Equation 4 ] & \\ S / P = \frac{{E}_{- 2 R}^{s} + {E}_{- 1 R}^{s} + {E}_{- 1 T}^{s}}{{E}_{- 2 R}^{p} + {E}_{- 1 R}^{p} + {E}_{- 1 T}^{p}} & ( 4 ) \\ [ Equation 5 ] & \\ η = \frac{{E}_{- 2 R}^{s} + {E}_{- 1 R}^{s} + {E}_{- 1 T}^{s} + {E}_{- 2 R}^{p} + {E}_{- 1 R}^{p} + {E}_{- 1 T}^{p}}{2} & ( 5 )\end{matrix}$$

In the equation (4), and the equation (5), E^{S}_{-2R}, E^{S}_{-1R}, and E^{S}_{-1T} show the diffraction efficiency of the −2 order reflection diffraction light 100R₋₂ with respect to the S polarization component, the diffraction efficiency with respect to the −1 order reflection diffraction light 100R₋₁, and the diffraction efficiency with respect to the −1 order transmission diffraction light 100T₋₁, respectively. Similarly, E^{P}_{-2R}, E^{P}_{-1R}, and E^{P}_{-1T} show the diffraction efficiency of the −2 order reflection diffraction light 100R₋₂ with respect to the P polarization component, the diffraction efficiency with respect to the −1 order reflection diffraction light 100R₋₁, and the diffraction efficiency with respect to the −1 order transmission diffraction light 100_{T-1}, respectively.

Furthermore, the reason why the −2 order transmission diffraction light 100T₋₂ in the S polarization component and the P polarization component is not included in the above-described calculation, is because the −2 order transmission diffraction light 100T₋₂ is rarely generated under the above described condition. Additionally, since the 0 order reflection diffraction light 100R₋₀ can be, in the range of the above-described incident angle θᵢₙ, practically considered as an inner reflection of the light guide plate main body 31, it is not included in the definitions of the total diffraction efficiency η and the S/P ratio.

Furthermore, a minimum value of the width w for calculation is set to be 25 nm (w/λ=0.05), and a maximum value is set to be 420 nm (w/λ=0.757), furthermore, a minimum value of the height d is set to be 0 nm, and a maximum value is set to be 420 nm (d/λ=0.757).

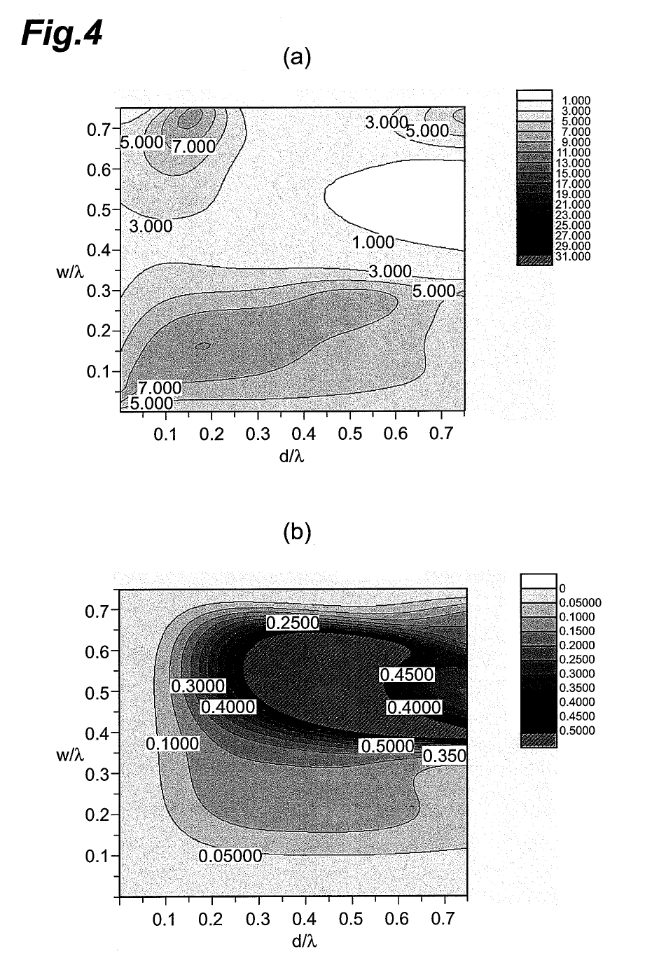

FIG. 4 to FIG. 10 are diagrams showing the S/P ratios and the total diffraction efficiencies η with respect to the widths w and the heights d when the refractive indexes n_{g} of the grating 33 are set to be 1.60, 1.65, 1.70, 1.75, 1.90, 2.05, and 2.50, respectively. In each diagram of FIG. 4 to FIG. 10, the S/P ratios and the total diffraction efficiencies η are processed in mapping with respect to values obtained by normalizing the widths w and the heights d by the wavelengths λ. Furthermore, in each diagram of FIG. 4 to FIG. 10, (a) shows a distribution of the S/P ratio with respect to w/λ, and d/λ, and (b) shows a distribution of the total diffraction efficiency η with respect to w/λ, and d/λ.

Based on a result shown in FIG. 4, corresponding relationships between w/λ and d/λ, and S/P ratio and the total diffraction efficiency η are shown in Table 1. Although omitted in Table 1, when the refractive index is 1.60, 9 is obtained as a maximum S/P ratio.

TABLE 1

| S/P ratio | η | w/λ | d/λ |
|---|---|---|---|
| 3 or more | 0.00-0.38 | 0.05-0.37 | 0.00-0.76 |
| | | 0.47-0.76 | 0.00-0.30 |
| 5 or more | 0.00-0.23 | 0.05-0.32 | 0.00-0.73 |
| | | 0.57-0.76 | 0.07-0.26 |
| 7 or more | 0.00-0.14 | 0.05-0.30 | 0.02-0.62 |
| | | 0.62-0.76 | 0.12-0.23 |
| 9 or more | 0.08 | 0.15-0.17 | 0.19-0.21 |
| | | 0.68-0.75 | 0.15-0.20 |

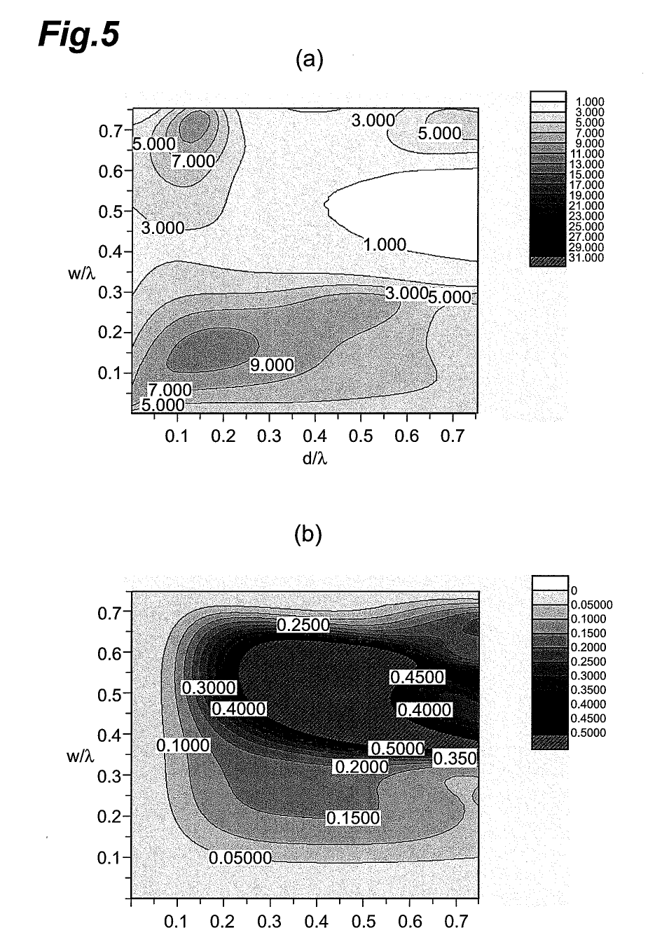

Furthermore, based on a calculation result shown in FIG. 5, corresponding relationships between w/λ and d/λ, and S/P ratio and the total diffraction efficiency η are shown in Table 2. Although omitted in Table 2, when the refractive index is 1.65, 10 is obtained as a maximum S/P ratio.

TABLE 2

| S/P ratio | η | w/λ | d/λ |
|---|---|---|---|
| 3 or more | 0.00-0.39 | 0.05-0.37 | 0.00-0.76 |
| | | 0.45-0.76 | 0.00-0.25 |
| | | 0.64-0.76 | 0.57-0.76 |
| 5 or more | 0.00-0.29 | 0.05-0.31 | 0.57-0.76 |
| | | 0.57-0.76 | 0.06-0.22 |
| | | 0.62-0.76 | 0.57-0.76 |
| 7 or more | 0.00-0.19 | 0.05-0.30 | 0.00-0.59 |
| | | 0.61-0.76 | 0.10-0.20 |
| 9 or more | 0.00-0.14 | 0.10-0.21 | 0.10-0.29 |
| | | 0.65-0.76 | 0.13-0.18 |

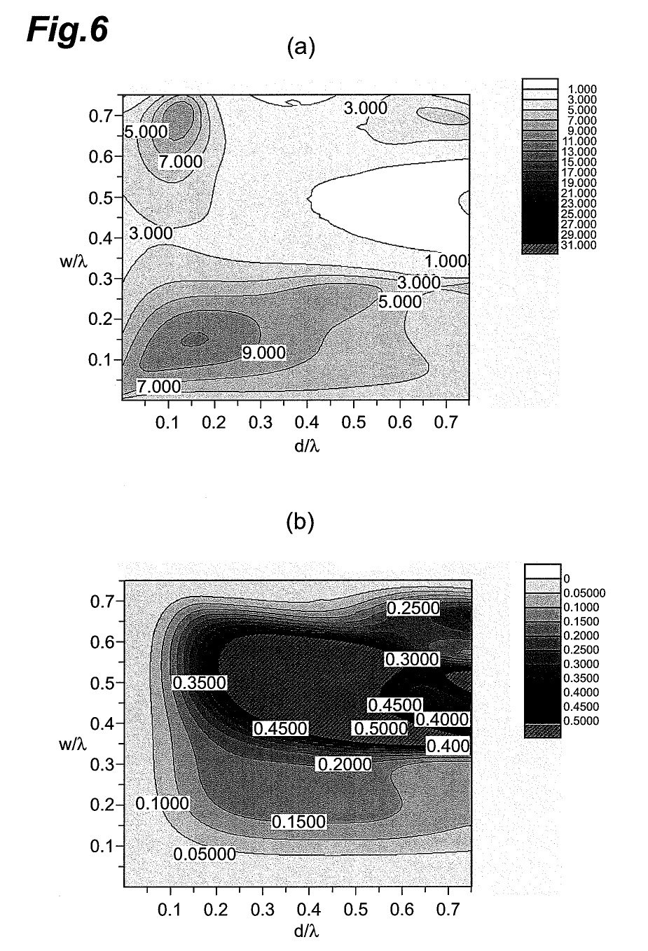

Based on a calculation result shown in FIG. 6, corresponding relationships between w/λ and d/λ, and S/P ratio and the total diffraction efficiency η are shown in Table 3. Although omitted in Table 3, when the refractive index is 1.70, 11 is obtained as a maximum S/P ratio.

TABLE 3

| S/P ratio | η | w/λ | d/λ |
|---|---|---|---|
| 3 or more | 0.00-0.50 | 0.05-0.40 | 0.00-0.76 |
| | | 0.42-0.76 | 0.00-0.24 |
| | | 0.62-0.76 | 0.54-0.76 |
| 5 or more | 0.00-0.36 | 0.05-0.32 | 0.00-0.68 |
| | | 0.55-0.76 | 0.05-0.21 |
| | | 0.66-0.70 | 0.65-0.76 |
| 7 or more | 0.00-0.25 | 0.05-0.30 | 0.00-0.50 |
| | | 0.60-0.76 | 0.09-0.19 |
| 9 or more | 0.01-0.17 | 0.06-0.31 | 0.08-0.20 |
| | | 0.11-0.17 | 0.64-0.72 |

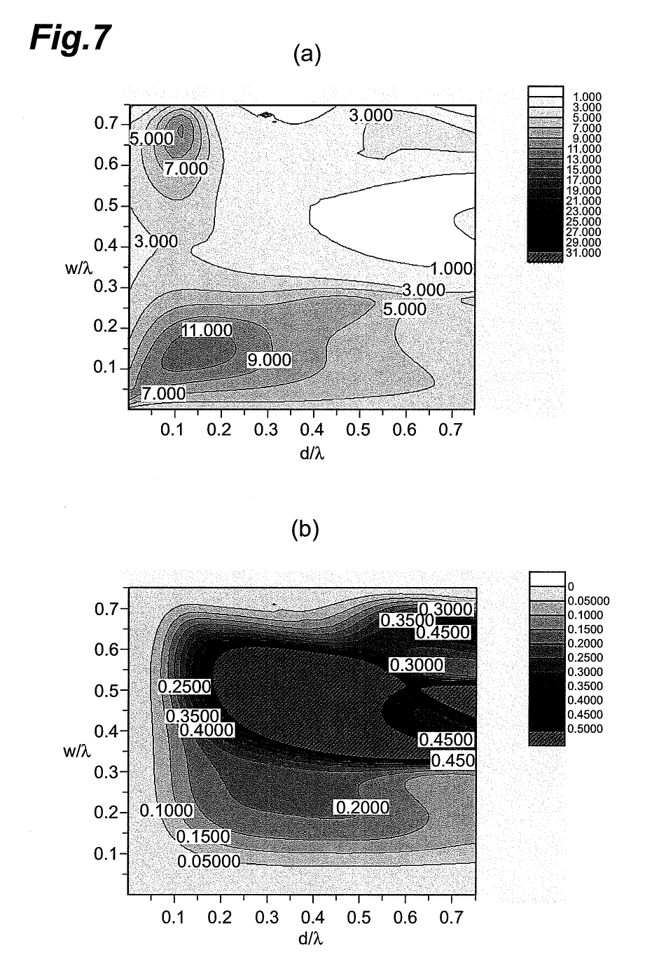

Based on a calculation result shown in FIG. 7, corresponding relationships between w/λ and d/λ, and S/P ratio and the total diffraction efficiency η are shown in Table 4. Although omitted in Table 4, when the refractive index is 1.75, 12 is obtained as a maximum S/P ratio.

TABLE 4

| S/P ratio | η | w/λ | d/λ |
|---|---|---|---|
| 3 or more | 0.00-0.51 | 0.05-0.42 | 0.00-0.76 |
| | | 0.42-0.76 | 0.00-0.22 |
| | | 0.62-0.76 | 0.52-0.76 |
| 5 or more | 0.00-0.39 | 0.05-0.32 | 0.00-0.66 |
| | | 0.53-0.76 | 0.06-0.20 |
| 7 or more | 0.00-0.28 | 0.05-0.30 | 0.00-0.52 |
| | | 0.59-0.76 | 0.08-0.18 |
| 9 or more | 0.00-0.20 | 0.10-0.27 | 0.00-0.32 |
| | | 0.62-0.76 | 0.09-0.16 |
| 11 or more | 0.02-0.17 | 0.15-0.25 | 0.10-0.25 |

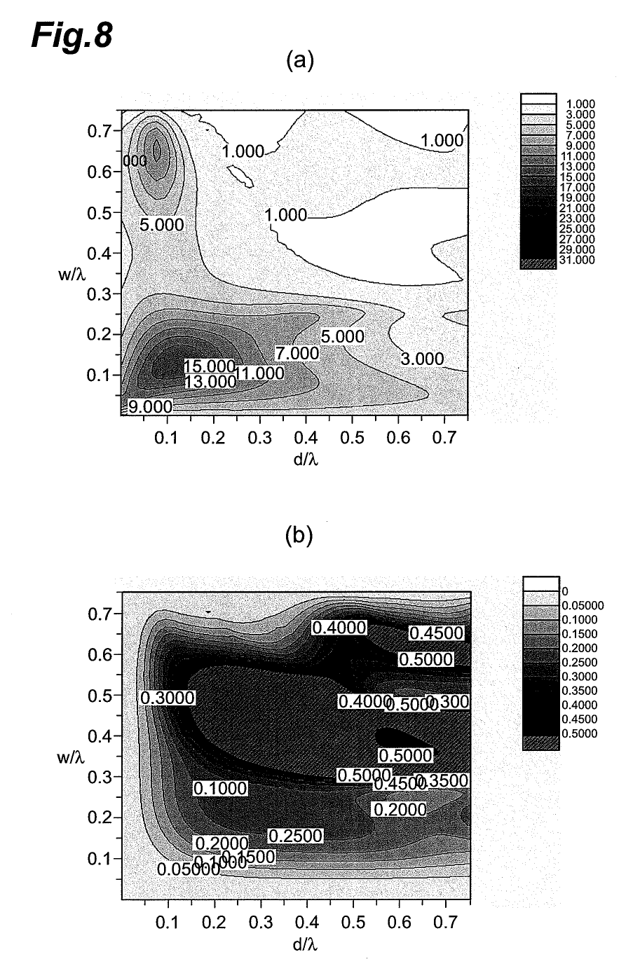

Based on a calculation result shown in FIG. 8, corresponding relationships between w/λ and d/λ, and S/P ratio and the total diffraction efficiency η are shown in Table 5. Although omitted in Table 5, when the refractive index is 1.90, 17 is obtained as a maximum S/P ratio.

TABLE 5

| S/P ratio | η | w/λ | d/λ |
|---|---|---|---|
| 3 or more | 0.00-0.53 | 0.05-0.35 | 0.00-0.76 |
| | | 0.35-0.72 | 0.00-0.18 |
| 7 or more | 0.00-0.37 | 0.05-0.28 | 0.00-0.42 |
| | | 0.53-0.70 | 0.05-0.13 |
| 11 or more | 0.00-0.26 | 0.05-0.23 | 0.00-0.29 |
| | | 0.63-0.69 | 0.09-0.11 |
| 15 or more | 0.03-0.20 | 0.11-0.18 | 0.08-0.19 |

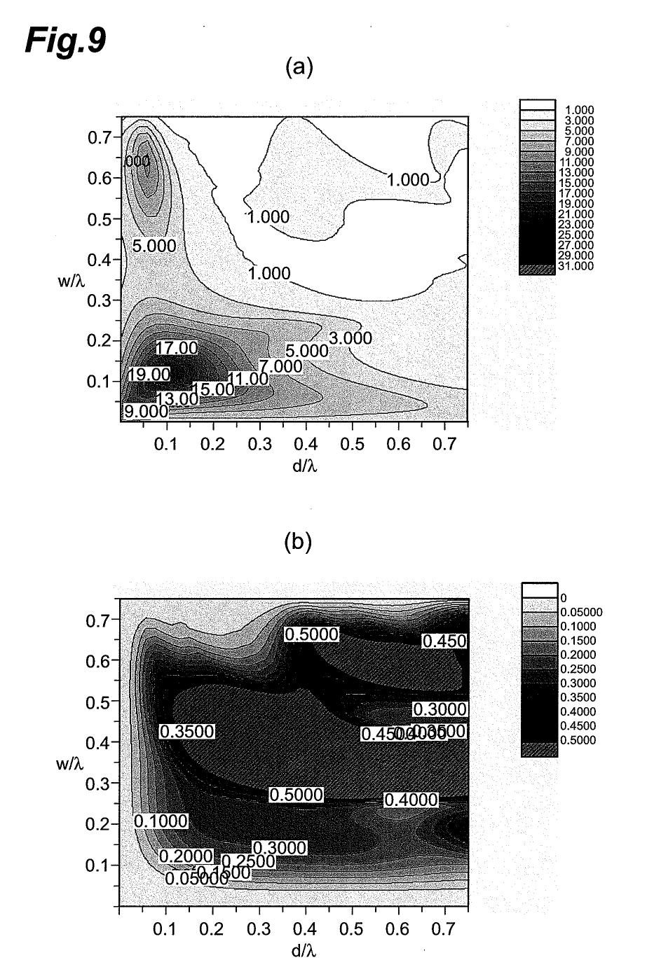

Based on a calculation result shown in FIG. 9, corresponding relationships between w/λ and d/λ, and S/P ratio and the total diffraction efficiency η are shown in Table 6. Although omitted in Table 6, when the refractive index is 2.05, 23 is obtained as a maximum S/P ratio.

TABLE 6

| S/P ratio | η | w/λ | d/λ |
|---|---|---|---|
| 3 or more | 0.00-0.54 | 0.05-0.35 | 0.00-0.76 |
| | | 0.35-0.72 | 0.00-0.15 |
| 7 or more | 0.00-0.37 | 0.05-0.28 | 0.00-0.42 |
| | | 0.50-0.70 | 0.07-0.10 |
| 11 or more | 0.01-0.31 | 0.05-0.24 | 0.00-0.28 |
| | | 0.63-0.67 | 0.06-0.08 |
| 15 or more | 0.02-0.30 | 0.06-0.15 | 0.01-0.25 |
| | | 0.19-0.21 | 0.46-0.60 |
| 19 or more | 0.03-0.24 | 0.13-0.17 | 0.08-0.16 |

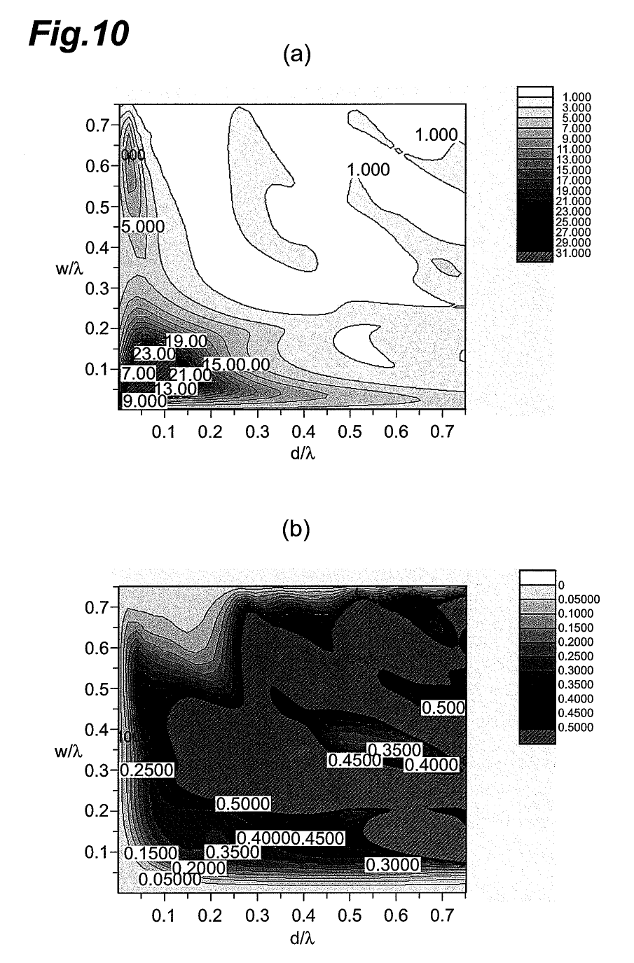

Based on a calculation result shown in FIG. 10, corresponding relationships between w/λ and d/λ, and S/P ratio and the total diffraction efficiency η are shown in Table 7. Although omitted in Table 7, when the refractive index is 2.50, 50 is obtained as a maximum S/P ratio.

TABLE 7

| S/P ratio | η | w/λ | d/λ |
|---|---|---|---|
| 3 or more | 0.00-0.56 | 0.05-0.30 | 0.00-0.40 |
| | | 0.05-0.13 | 0.40-0.76 |
| | | 0.30-0.72 | 0.00-0.14 |
| 7 or more | 0.00-0.42 | 0.05-0.28 | 0.00-0.45 |
| | | 0.48-0.70 | 0.03-0.07 |
| 11 or more | 0.00-0.38 | 0.05-0.22 | 0.00-0.30 |
| 15 or more | 0.00-0.38 | 0.05-0.21 | 0.00-0.25 |
| 21 or more | 0.01-0.37 | 0.05-0.17 | 0.00-0.18 |

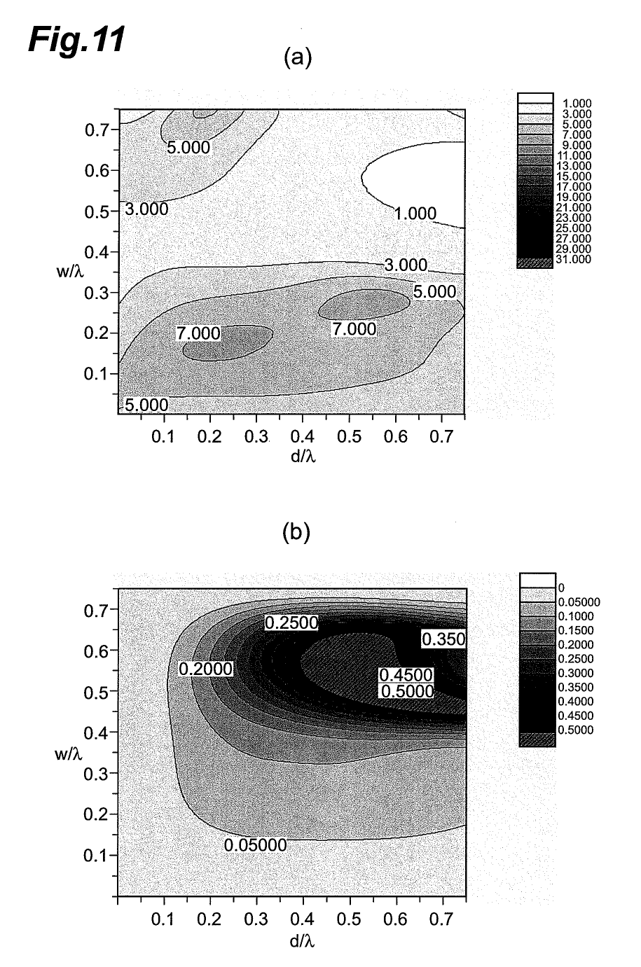

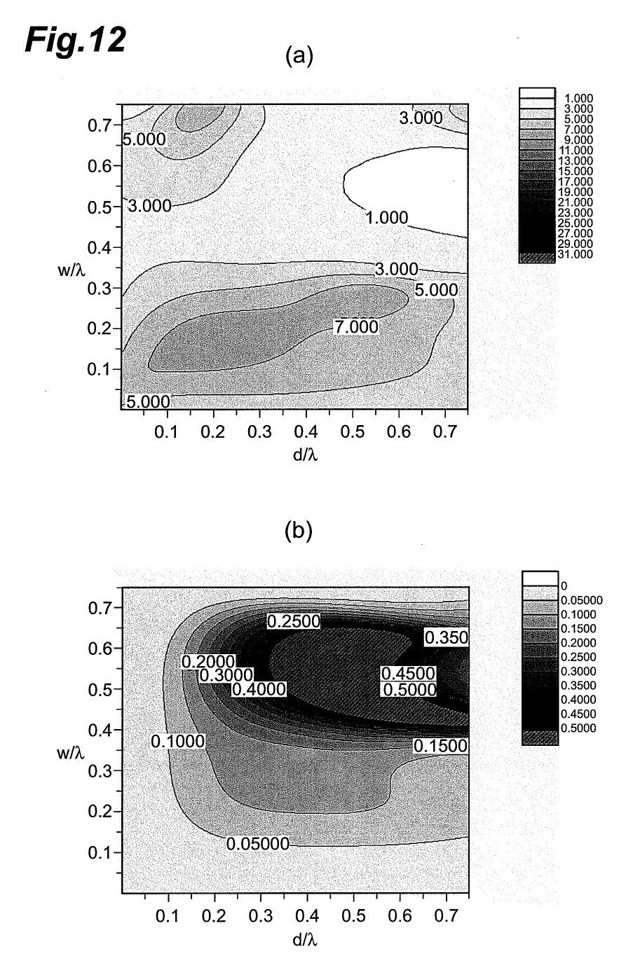

Furthermore, for making a comparison, calculation results when the refractive indexes of the grating 33 are 1.50, and 1.55 are shown in FIG. 11, and FIG. 12, respectively. In FIG. 11, and FIG. 12, as with the case of FIG. 4 to FIG. 10, the S/P ratio and the total diffraction efficiency η are processed in mapping with respect to a value obtained by normalizing the width w and the height d by the wavelength k. Additionally, in FIG. 11 and FIG. 12, (a) shows a distribution of the S/P ratio with respect to w/λ and d/λ, and (b) shows a distribution of the total diffraction efficiency η with respect to w/λ and d/λ.

Based on a calculation result shown in FIG. 11, corresponding relationships between w/λ and d/λ, and S/P ratio and the total diffraction efficiency η are shown in Table 8. Although omitted in Table 8, when the refractive index is 1.50, 8 is obtained as a maximum S/P ratio.

TABLE 8

| S/P ratio | η | w/λ | d/λ |
|---|---|---|---|
| 3 or more | 0.00-0.18 | 0.05-0.38 | 0.00-0.76 |
| | | 0.51-0.76 | 0.00-0.34 |
| 5 or more | 0.00-0.11 | 0.05-0.35 | 0.00-0.76 |
| | | 0.65-0.76 | 0.11-0.28 |
| 7 or more | 0.03-0.09 | 0.14-0.22 | 0.25-0.35 |
| | | 0.16-0.35 | 0.45-0.65 |

Furthermore, based on a calculation result shown in FIG. 12, corresponding relationships between w/λ and d/λ, and S/P ratio and the total diffraction efficiency η are shown in Table 9. Although omitted in Table 9, when the refractive index is 1.55, 8 is obtained as a maximum S/P ratio.

TABLE 9

| S/P ratio | η | w/λ | d/λ |
|---|---|---|---|
| 3 or more | 0.00-0.30 | 0.05-0.36 | 0.00-0.76 |
| | | 0.50-0.76 | 0.00-0.31 |
| 5 or more | 0.00-0.13 | 0.05-0.32 | 0.00-0.72 |
| | | 0.62-0.76 | 0.08-0.28 |
| 7 or more | 0.01-0.12 | 0.10-0.03 | 0.10-0.63 |
| | | 0.68-0.76 | 0.13-0.24 |

As shown in FIG. 4 to FIG. 10, and Table 1 to Table 7, by the reason that the refractive index difference n_{d} between the grating 33 and the light guide plate main body 31 satisfies the equation (3), the polarization separation can be apparently generated. Furthermore, as the refractive index difference n_{d} increases, an even greater S/P ratio and total diffraction efficiency η can be realized. Additionally, in the case, shown for making a comparison, that the refractive index n_{g} is 1.50 and 1.55, that is, even when the refractive index difference n_{d} is 0.05 and 0.10, since 3 or more can be realized in the S/P ratio, the polarization separation is possible.

However, in the total diffraction efficiency that can be realized when the refractive index difference is 1.50 and 1.55, for example, it is not practical to be used as a backlight of the liquid crystal display device 1. Therefore, as described above, it is necessary for the refractive index difference n_{d} to be 0.15 or more. Furthermore, by making the refractive index difference n_{d} 0.15 or more, an adjusting range of the total diffraction efficiency η in each S/P ratio becomes wide. This makes an adjustment of the total diffraction efficiency η easy. Furthermore, when the refractive index n_{g} shown for making a comparison is 1.50 and 1.55, the maximum S/P ratios are mutually 8 or so together, and a variation range of S/P ratio with respect to a variation of the refractive index difference n_{d} is small (For example, the maximum S/P ratio is rarely varied.), furthermore, by making the refractive index n_{g} 1.60 or more, that is, the refractive index difference n_{d} 0.15 or more, the maximum S/P ratio is set to be 9 or more, and the S/P ratio can be apparently increased with respect to a variation of the refractive index difference n_{d} simultaneously. Accordingly, by making the refractive index difference n_{d} 0.15 or more, the adjusting range of the S/P ratio is widened. Furthermore, the refractive index difference n_{d} is expected to be 0.15 or more, from the point of view of realizing an even higher S/P ratio and an even wider adjustment range of the diffraction efficiency, 0.50 or more is further desired.

Furthermore, the results shown in Table 1 to Table 7 show that, as the width w increases, the S/P ratio becomes small, on the other hand, the total diffraction efficiency η tends to increase, and when a height d of the diffraction grating section 32 is increased, both of the S/P ratio and the total diffraction efficiency η tend to increase. Therefore, by selecting the width w and the height d by considering such a tendency, desired S/P ratio and total diffraction efficiency η can be realized. From the point of view that an even higher S/P ratio is realized, and the adjusting range of the total diffraction efficiency η is widened, w/λ is desirable to be 0.13-0.17, and d/λ is desirable to be 0.08-0.16. By setting w/λ and d/λ in this range, the refractive index difference can be made to be 0.50 or more, and the S/P ratio can be made to be 7 or more, furthermore, the total diffraction efficiency η can be adjusted in an even wider range.

In a calculation regarding a relationship between the above-described refractive index difference n_{d} and the polarization separation degree, although the wavelength λ is assumed to be 555 nm, even when the wavelength λ is set to be 470 nm of a blue color system, and 630 nm of a red color system, the polarization separation can be generated by satisfying the equation (3).

One example of calculation result when the wavelength λ is set to be 470 nm by adopting 420 nm equal to the above-described calculation condition as the interval Λ is shown in Table 10 and Table 11. The calculation condition adopts 470 nm instead of 555 nm as the wavelength λ, Table 10 shows a result when the refractive index n_{g} is 1.60, and Table 11 shows a result when the refractive index n_{g} is 2.05. The creating method of Table 10 and Table 11 is the same as the case that the wavelength λ is 555 nm. That is, after calculating the S/P ratio and the total diffraction efficiency while changing w/λ and d/λ, the calculation result is processed in the mapping with respect to w/λ and d/λ, furthermore, corresponding relationships between w/λ and d/λ, and the S/P ratio and the total diffraction efficiency η are arranged in Table 10 and Table 11. Although not shown in Table 10 and Table 11, when the refractive index n_{g} is 1.60, and the refractive index n_{g} is 2.05, 8 and 11 are obtained as the maximum S/P ratio, respectively.

TABLE 10

| S/P ratio | η | w/λ | d/λ |
|---|---|---|---|
| 3 or more | 0.00-0.60 | 0.06-0.32 | 0.00-0.23 |
| | | 0.26-0.72 | 0.07-0.98 |
| 5 or more | 0.12-0.28 | 0.39-0.56 | 0.70-0.98 |
| 7 or more | 0.16-0.22 | 0.41-0.50 | 0.79-0.91 |

TABLE 11

| S/P ratio | η | w/λ | d/λ |
|---|---|---|---|
| 3 or more | 0.00-0.60 | 0.06-0.83 | 0.00-0.55 |
| | | 0.14-0.42 | 0.65-0.98 |
| 5 or more | 0.00-0.49 | 0.06-0.22 | 0.00-0.32 |
| | | 0.23-0.38 | 0.78-0.98 |
| 7 or more | 0.02-0.44 | 0.06-0.15 | 0.02-0.11 |
| | | 0.24-0.35 | 0.86-0.98 |
| 9 or more | 0.30-0.39 | 0.27-0.32 | 0.93-0.98 |

One example of calculation result when the wavelength λ is set to be 640 nm by adopting 420 nm equal to the above-described calculation condition as the interval Λ is shown in Table 12 and Table 13. Table 12 shows a result when the refractive index n_{g} is 1.60, and Table 13 shows a result when the refractive index n_{g} is 2.05. The creating method of Table 12 and Table 13 is the same as the case that the wavelength λ is 555 nm. Although not shown in Table 12 and Table 13, when the refractive index n_{g} is 1.60, and the refractive index n_{g} is 2.05, 12 and 17 are obtained as the maximum S/P ratio, respectively.

TABLE 12

| S/P ratio | η | w/λ | d/λ |
|---|---|---|---|
| 5 or more | 0.00-0.20 | 0.04-0.42 | 0.00-0.64 |
| 7 or more | 0.01-0.20 | 0.07-0.15 | 0.17-0.31 |
| | | 0.18-0.38 | 0.38-0.64 |
| 9 or more | 0.11-0.19 | 0.22-0.35 | 0.44-0.64 |
| 11 or more | 0.12-0.18 | 0.28-0.32 | 0.51-0.63 |

TABLE 13

| S/P ratio | η | w/λ | d/λ |
|---|---|---|---|
| 6 or more | 0.00-0.48 | 0.04-0.28 | 0.00-0.64 |
| 9 or more | 0.00-0.43 | 0.04-0.25 | 0.00-0.64 |
| 12 or more | 0.00-0.39 | 0.04-0.18 | 0.04-0.32 |
| | | 0.17-0.22 | 0.39-0.64 |
| 15 or more | 0.02-0.30 | 0.06-0.15 | 0.01-0.25 |
| | | 0.19-0.21 | 0.46-0.60 |

Results shown in Table 10 to Table 13 show that even when a different light with wavelength λ is made incident to the diffraction grating section 32 having the same interval Λ, since the refractive index difference n_{d} is 0.15 or more, the polarization separation can be generated. Therefore, the polarization separation is possible by satisfying the equation (3).

As described above, the diffraction grating section 32 has an emission angle control function and a polarization separation function by satisfying the equation (1) and the equation (3), and one diffraction grating section 32 can realize both functions of the diffraction grating section which is provided by the conventional Holographic light guide plate and the wire grid. The diffraction grating section 32 like this can be manufactured as follows.

That is to say, first, a layer consisting of a material of the grating 33 selected so that it may satisfy the equation (3) is formed on the emission surface 31b of the light guide plate main body 31 so that thickness may become d. Next, so that the grating 33 with width w may be arranged at the interval Λ set to satisfy the equation (1), one part of the layer on the emission surface 31b is removed using, for example, a lithography technique or the like. The width w and the height d, as described above, have only to be preset by a desirable polarization separation degree and diffraction efficiency.

Furthermore, when setting the interval Λ to satisfy the equation (1), the wavelength λ used is further desirable to be a wavelength close to the center (550 nm) in a wavelength of a visible region. By setting the interval Λ with respect to this wavelength, a gap from a designed value of the emission angle θₒᵤₜ which is caused by a difference between the wavelength λ for design and the other wavelength in the visible region can be made little. Additionally, by considering the gap from the designed value of the emission angle θₒᵤₜ which is caused by the difference between the wavelength λ used for the design like this and the other wavelength in the visible region, the emission angle θₒᵤₜ in the visible region is desirable to locate within a range of −30° to 30° by referring to the normal line Nb direction.

The light guide plate 30, as described above, satisfies the equation (1) and the equation (3), and is a multifunctional optical sheet equipped with the diffraction grating section 32 having the polarization separation function and the emission angle control function on the emission surface 31b of the light guide plate main body 31. Since the light guide plate 30 is equipped with the diffraction grating section 32 satisfying the equation (1) and the equation (3), the emission light 101, in which the S polarization component is further predominant, is output from the emission surface 31b toward the liquid crystal display element 10. As a result, from the surface light source device 40 equipped with the light guide plate 30, a surface beam, in which the S polarization component is further predominant, converged so that it may propagate toward the liquid crystal element 10 side can be output.

Conventionally, when a light in non-polarization state is emitted in various directions from the emission surface as merely a backlight from the surface light source device, between the surface light source device and the transmission image display element, a prism sheet for adjusting a propagation direction of the emission light to approach a normal line of the emission surface, or a polarization separation element or the like for separating unnecessary polarization from the emission light for reusing the unnecessary polarization cut by a polarizing plate of the transmission image display element is required to be arranged.

On the contrary, since in the light guide plate 30 of the present embodiment, and the surface light source device 40 equipped with it, the surface beam high in a ratio of the S polarization component can be output toward the liquid crystal display element 10, as shown in FIG. 1, the emission light 101 from the light guide plate 30 can be directly made incident to the liquid crystal display element 10. In this way, since the prism sheet or the like conventionally arranged between the light guide plate 30 and the liquid crystal display element 10 is unnecessary, the liquid crystal display device 1 can be downsized and made thin.

Furthermore, since the light guide plate 30 is equipped with the reflector 34 on the rear surface 31c of the light guide plate main body 31, in the reflection diffraction light 100 R₋ₘ diffracted inside the light guide plate main body 31 by the diffraction grating section 32, for example, as with the reflection diffraction light 100R₋₁ shown in FIG. 2, a diffraction light made incident at an angle smaller than the critical angle with respect to the rear surface 31c can be emitted from the emission surface 31b side. As a result, the light 100 made incident from the incident surface 31a can be effectively utilized. It is concretely explained using the case shown in FIG. 2 as an example.

As shown in FIG. 2, since the 0 order reflection diffraction light 100R₋₀ and the −2 order reflection diffraction light 100R₋₂ in a reflection diffraction light 100R₋ₘ roughly satisfy the total reflection condition, they can propagate inside the light guide plate main body 31 without being equipped with the reflector 34. Since this reflection diffraction light 100R₋₀ and reflection diffraction light R₋₂ are made incident to the emission surface 31b at the incident angle θᵢₙ greater than the total reflection angle, as with the case that the light 100 before having been diffracted is made incident to the diffraction grating section 32, a transmission diffraction light 100Tₘ and a reflection diffraction light 100R₋ₘ are generated.

On the contrary, since the −1 order reflection diffraction light 100R₋₁ shown in FIG. 2 does not satisfy the total reflection condition, when the reflector 34 is not provided, it leaks outside from the rear surface 31c. However, since the light guide plate 30 is equipped with the reflector 34, the −1 order reflection diffraction light 100R₋₁ is reflected by the reflector 34 and made incident again to the diffraction grating section 32. Since in the reflection diffraction light 100R₋₁ made incident again, the incident angle θᵢₙ becomes smaller than the total reflection angle, it is emitted to the outside of the light guide plate 30 as the 0 order transmission diffraction light, and becomes the emission light 101. Even when the reflection diffraction light 100R₋₁ is emitted in this way, as shown in FIG. 3, the reflection diffraction light 100R₋₁ can be preferably utilized as a backlight, since the S polarization component is predominant.

Furthermore, since the −1 order reflection diffraction light 100R₋₁, in which the S polarization component is predominant, is emitted from the emission surface 31b side as the 0 order transmission diffraction light 100T₀ as described above, a reflection by the reflector 34 is desirable to be a specular reflection without changing the polarization state.

Additionally, since the polarization converting element 35 is provided on the side surface 31d side of the light guide plate main body 31, as described above, the light 100, in which the P polarization component is further predominant, propagated toward the side surface 31d side can be returned inside the light guide plate main body 31 by converting polarization. Therefore, the light 100 of the P polarization component which is returned inside the light guide plate main body 31 by a diffraction in the diffraction grating section 32 can also be further effectively utilized.

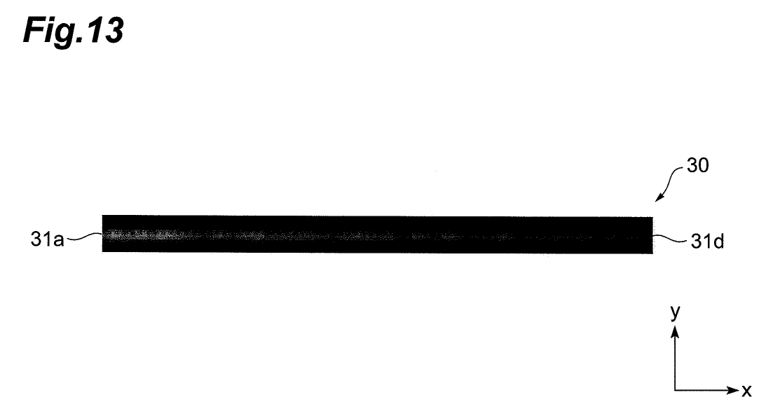

A way that the emission light 101 can be emitted from the emission surface 31b side by the above-described light guide plate 30 is concretely explained based on a calculation result. FIG. 13 is a diagram showing the calculation result of illumination distribution of the emission light from the light guide plate by a light source tracing method. In FIG. 13, re-incidence from the polarization converting element 35 is also considered.

A calculation condition for a tracing light beam is as follows:
A size of the light guide plate main body 31 (W1×W2×D): 10 mm×10 mm×1 mm
Wavelength λ: 555 nm
The refraction index nₛ of the light guide plate main body 31: 1.45
The interval Λ: 420 nm
The refraction index n_{g} of the grating 33: 2.05
The height d of the grating 33: 65 nm
The width w of the grating: 65 nm

In the above-described calculation condition, when the S/P ratio, the total diffraction efficiency, and the polarization degree of the emission light 101 when the light 100 made incident from the incident surface 31a is made incident one time to the diffraction grating section 32 are calculated, the following result is obtained:
The S/P ratio: 22.56
The total diffraction efficiency η: 0.110
The polarization degree of the emission light: approximately 0.89
   Furthermore, the polarization degree of the emission light 101, when intensities of the S polarization component and the P polarization component are set to be S and P, is (S+P)/(S+P).

For example, since the polarization degree after passing through the conventional reflection polarizing plate (for example, DBEF manufactured by 3M Corporation) is approximately 0.6 or so, the light having a polarization degree higher than the conventional one is found to be generated as the emission light 101. Furthermore, as shown in FIG. 2, by utilizing the diffraction grating section 32 configured by including the grating 33 sized by the above-described width w and height d, even in the side surface 31d side, the emission light 101 is reliably emitted.

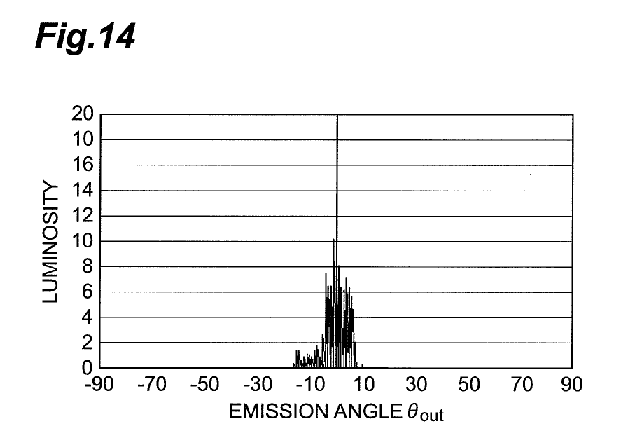

FIG. 14 is a diagram showing emission angle distribution in the calculation result shown in FIG. 13. In FIG. 14, an axis of abscissas shows the emission angle θₒᵤₜ, and an axis of ordinate shows luminosity. As shown in FIG. 14, in the above-described condition, the emission light 101 can be emitted within a range of approximately −10° to 10° with respect to the normal line Nb direction of the emission surface 31b, therefore, the emission light 101 can be emitted roughly in the normal line Nb direction.

When a condition except for wavelength is the same as the case shown in FIG. 14, and calculation is performed using the wavelength 470 nm of a blue color system instead of the wavelength 555 nm, the emission angle range is −5° to 25°, and when calculation is performed using the wavelength 630 nm of the red color system, the emission angle range is −30° to −5°. Therefore, using the interval Λ set with respect to the wavelength 555 nm, light can be emitted in the range of −30° to 30° by referring to the normal line Nb direction with respect to both of a blue color system light and the green color system light.

### Second Embodiment

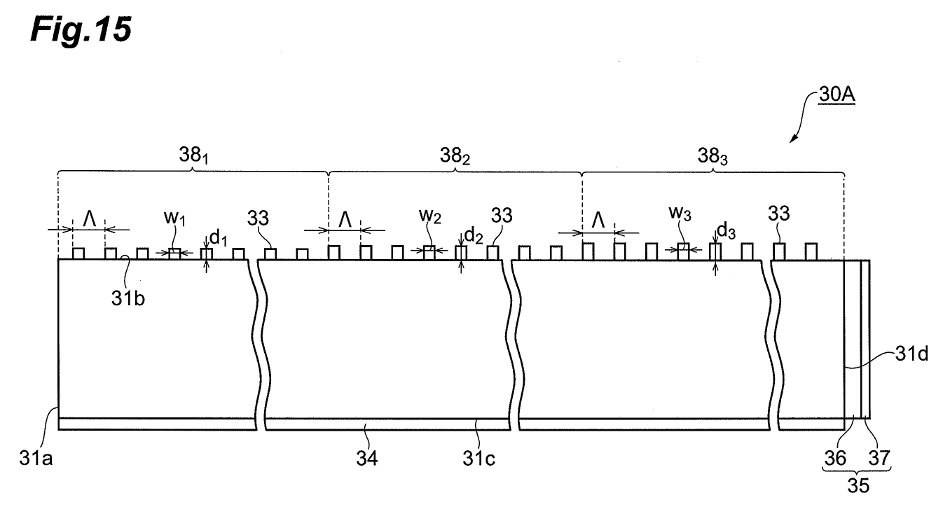

FIG. 15 is a side view schematically showing a configuration of another embodiment of the light guide plate according to the present invention. A light guide plate 30A differs from the light guide plate 30 in a point that a diffraction grating section 32A is provided instead of the diffraction grating section 32. A configuration of the light guide plate 30A except for this different point is the same as the configuration of the light guide plate 30 shown in FIG. 1 and FIG. 2. This light guide plate 30A, as with the case of the light guide plate 30, is preferably utilized for the liquid crystal display device 1, and the surface light source device 40 applied to it. Hereinafter, regarding the light guide plate 30A, the configuration of the diffraction grating section 32A which is a different point with the light guide plate 30 is mainly explained.

The diffraction grating section 32A is configured in such a manner that the grating 33 consisting of a dielectric material of the refraction index n_{g} which satisfies the equation (3) is arranged at the interval Λ satisfying the equation (1). Therefore, in the diffraction grating section 32A as with the case of the diffraction grating section 32, the light of the S polarization component in the light 100 propagating inside the light guide plate main body 31 can be mainly emitted toward the liquid crystal display element 10. In other words, the diffraction grating section 32 also has the polarization separation function and the emission angle control function. As a result, the diffraction grating section 32A gives the same action effect as the diffraction grating section 32 shown in FIG. 1.

Furthermore, the diffraction grating section 32A includes a first to an Mth diffraction regions of 38₁ to 38_{M} different in the width w and the height d of the grating 33. In this point, the configuration of the diffraction grating section 32A differs from the configuration of the diffraction grating section 32 shown in FIG. 1 and FIG. 2. Here, the widths w of the grating 33 within the first to the Mth diffraction regions 38₁ to 38_{M}, and the heights d of the grating 33 within the first to the Mth diffraction regions 38₁ to 38_{M} are also called widths w₁ to w_{M} and heights d₁ to d_{M}, respectively. In FIG. 15, the case of M=3 is shown as one example.

Since the first to the Mth diffraction regions 38₁ to 38_{M} include the grating 33 arranged at the interval Λ, respectively, each of the first to the Mth diffraction regions 38₁ to 38_{M} functions as a diffraction grating section satisfying the equation (1), and the equation (3). Furthermore, in the widths w₁ to w_{M} and the heights d₁ to d_{M} of the grating 33 within the first to the Mth diffraction regions 38₁ to 38_{M}, they are set so that the extraction efficiency of the light 100 may increase as they approach the side surface 31d in the first to the Mth diffraction regions 38₁ to 38_{M}. When the total diffraction efficiency in the diffraction grating section 32A is high, since the extraction efficiency increases as a result, the total diffraction efficiency of each of the first to the Mth diffraction regions 38₁ to 38_{M} increases as it approaches the side surface 31d side.

As described above, in the diffraction grating section 32A, the light of the S polarization component is made to be mainly diffracted to the liquid crystal display element 10 side. Therefore, as the light 100 made incident from the incident surface 31a approaches the side surface 31d side, the P polarization component increases in the light 100 propagating inside the light guide plate main body 31. In other words, the S polarization component decreases. Therefore, so that a reduction part of this S polarization component may be compensated, by increasing the total diffraction efficiency in the first to the Mth diffraction regions 38₁ to 38_{M}, the light can be emitted substantially uniformly from the emission surface 31b in the x axis direction. The adjustment of the total diffraction efficiency can be implemented by adjusting at least one side, for example, of the widths w₁ to w_{M} and the heights d₁ to d_{M}.

In this way, when the light guide plate 30A is equipped with the diffraction grating section 32A having the first to the Mth diffraction regions 38₁ to 38_{M}, since the reduction part of the S polarization component can be compensated by differences of total diffraction efficiency between the first to the Mth diffraction regions 38₁ to 38_{M}, a configuration, in which, for example, the polarization converting element 35 is not provided, can be adopted. However, when the polarization converting element 35 is not provided, it is desirable that the reflector is provided in the side surface 31d so that the light may not leak from the side surface 31d from the point of view that the light 100 made incident inside the light guide plate main body 31 is utilized effectively. Moreover, as shown in FIG. 15, it is desirable that the diffraction grating section 32A and the polarization converting element 35 is combined, form the point of view that a uniformity of illumination in the x axis direction can be further reliably provided.

### Third Embodiment

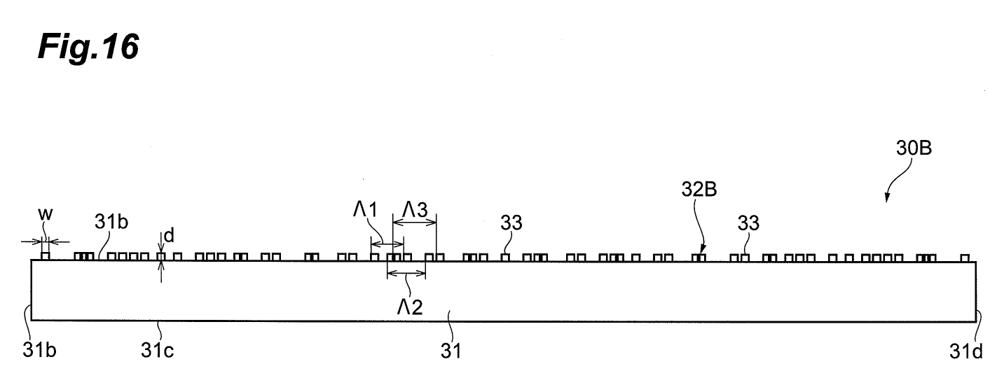

FIG. 16 is a side view schematically showing a configuration of still another embodiment of the light guide plate according to the present invention. The light guide plate 30B mainly differs in configuration from the light guide plate 30 from the point that the diffraction grating section 32B is provided instead of the diffraction grating section 32. A configuration of the light guide plate 30B except for this different point is the same as a configuration of the light guide plate 30. Furthermore, in FIG. 16, descriptions of the reflector 34 and the polarization converting element 35 are omitted. This light guide plate 30B, as with the case of the light guide plate 30, can be preferably utilized to the liquid crystal display device 1, and the surface light source device 40 applied to it. Hereinafter, regarding the light guide plate 30B, the configuration of the diffraction grating section 32B being the different point with the light guide plate 30 is mainly explained.

The diffraction grating section 32B is configured by including a plurality of the gratings 33 having the refractive index n_{g} satisfying the equation (3). A plurality of gratings 33 can be divided into a grating group arranged at an interval Λ1, a grating group arranged at an interval Λ2, and a grating group arranged at an interval Λ3. In other words, the diffraction grating section 32B corresponds to a member in which 3 diffraction grating sections formed by arranging each grating 33 at the intervals of Λ1, Λ2, and Λ3 are put together.

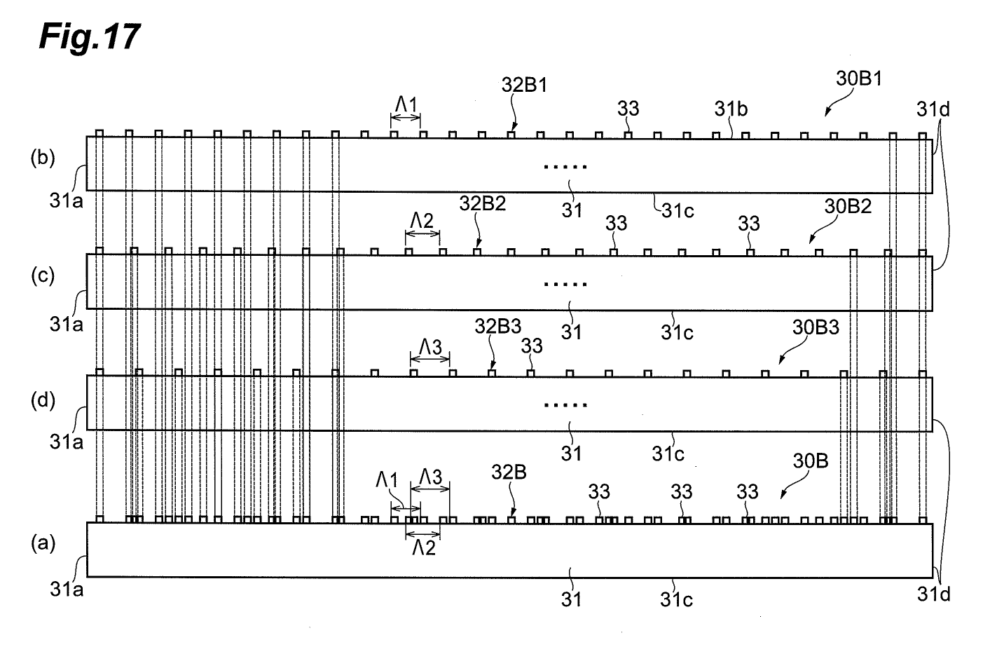

By utilizing FIG. 17, the diffraction grating section 32B is explained more concretely. FIG. 17 is a pattern view of the light guide plate for explaining the configuration of the diffraction grating section shown in FIG. 16. FIG. 17(a) is a pattern view of the light guide plate equipped with the diffraction grating section including the grating 33 arranged at the intervals Λ1 to Λ3, respectively. FIG. 17(b) is a pattern view of the light guide plate when the grating group of the interval Λ1 is extracted from the diffraction grating section shown in FIG. 17(a). FIG. 17(c) is a pattern view of the light guide plate when the grating group of the interval Λ2 is extracted from the diffraction grating section shown in FIG. 17(a). Similarly, FIG. 17(d) is a pattern view of the light guide plate when the grating group of the interval Λ3 is extracted from the diffraction grating section shown in FIG. 17(a).

The light guide plates 30B1, 30B2, and 30B3 shown in FIG. 17(b) to FIG. 17(d) correspond to members equipped with the diffraction grating sections 32B1 to 32B3 formed by arranging the gratings 33 at the intervals Λ1, Λ2, and Λ3 which are defined so that they may satisfy the equation (1) with respect to the wavelengths λ1, λ2, and λ3, respectively. Accordingly, each of light guide plate 30B1 to 30B3 gives the same action effect as that of the light guide plate 30. Furthermore, the wavelength λ1 is illustrated by 420 nm of the blue color system, and the wavelength λ2 is illustrated by 555 nm of the green color system, furthermore, the wavelength λ3 is illustrated by 630 nm of the red color system. The intervals Λ1, Λ2, and Λ3 are illustrated by 360 nm, 420 nm, and 480 nm with respect to the above-described illustrated wavelengths λ1, λ2, and λ3, respectively.

Additionally, in the diffraction grating section 32B included by the light guide plate 30B shown in FIG. 17(a), the grating group consisting of a plurality of the gratings 33 constituting the diffraction grating sections 32B1 to 32B3 shown in FIG. 17(b) to FIG. 17(d) is configured by being put together on one emission surface 31b.

Accordingly, the lights of the wavelengths λ1, λ2, and λ3 included in the light 100 made incident from the incident surface 31a are diffracted in accordance with the grating group arranged at the intervals Λ1, Λ2, and Λ3 in the diffraction grating section 32B, respectively. In other words, the diffraction is performed as with the case that the lights of the wavelengths λ1, λ2, and λ3 are made incident to each of light guide plate 30B1 to 30B3 shown in FIG. 17(b) to FIG. 17(d), respectively. As a result, in the light guide plate 30B, the S polarization component included in the lights of the wavelengths λ1, λ2, and λ3 can be more reliably diffracted to the liquid crystal element 10 side being the outside of the light guide plate main body 31.

By the light guide plate 30B in this way, since the diffraction grating section 32B is formed in such a way that the grating group designed with respect to 3 wavelengths λ1, λ2, and λ3 selected from the visible region is put together, higher polarization separation degree can be realized with respect to the light of each wavelength included in the visible region, and in the wavelength range of the visible region included in at least the light 100, the surface beam, in which a spreading from the normal line Nb direction is suppressed, can be emitted simultaneously. Therefore, when color is displayed in the liquid crystal display device 1, color unevenness or the like can be suppressed.

Furthermore, as described above, the diffraction grating section 32B is regarded as a configuration in which the gratings 33 constituting the diffraction grating sections 32B1 to 32B3, respectively, are put together on the emission surface 31b. Each of diffraction grating sections 32B1 to 32B3 corresponds to the diffraction grating section 32, which is explained in the first embodiment, satisfying the equation (1) and the equation (3). Furthermore, when higher S/P ratio is realized, since the diffraction grating section 32 has the polarization separation function, the width w of the grating 33 tends to be small as shown in Table 1 to Table 7. Therefore, it is easy to form one diffraction grating section 32B by putting together the grating group constituting each of the diffraction grating sections 32B1 to 32B3 satisfying the equation (1) and the equation (3) on the emission surface 31b.

As described above, although the embodiments of the present invention are explained, the present invention is not limited to the above-described embodiments. For example, although in the light guide plates 30, 30A, and 30B, the reflector 34 as a light route converting means is arranged so that it may be close to the rear surface 31c, and the polarization converting element 35 is arranged so that it may be close to the side surface 31d, the light guide plates 30, 30A, and 30B may not be equipped with the reflector 34 and the polarization converting element 35. For example, the surface light source device 40 may be equipped with the reflector 34 arranged beneath the rear surface 31c by being separated from the rear surface 31c. Similarly, the surface light source device 40 may have the polarization converting element 35 arranged on a side of the side surface 31d by being separated from the side surface 31d. Furthermore, although it is desirable that the reflector 34 is utilized from the point of view that the light 100 made incident to the light guide plate 30 is utilized effectively, since most of the light 100 propagates by the total reflection inside the light guide plate main body 31, a configuration, in which each of the light guide plates 30, 30A, and 30B, and the surface light source device 40 is not equipped with the reflector 34, can be realized. Furthermore, for example, as shown in the second embodiment, a configuration, in which the polarization converting element 35 is not provided, can be realized in such a way that light extraction efficiency in x axis direction is adjusted. Additionally, although the light guide plates 30, 30A, and 30B, and the surface light source device 40 are explained to be applied to the liquid crystal display device 1, the light guide plates 30, 30A, and 30B, and the surface light source device 40 can be preferably applied to the transmission image display device such as the liquid crystal display device 1. Furthermore, although among the incident surface 31a, the emission surface 31b, the rear surface 31c, and the side surface 31d, surfaces to face one another are to be parallel, the present invention is not limited to this. When the light 100 made incident from the incident surface 31a can be propagated inside the light guide plate main body 31, and the light, in which the S polarization component is predominant, can be extracted as the emission light 101 from the emission surface 31b, for example, at least one side of the incident surface 31a and the side surface 31d may be inclined with respect to the emission surface 31b. In this way, the incident angle θᵢₙ can be adjusted by making the incident surface 31a, and the side surface 31d inclined.

What is claimed is:

1. A light guide plate comprising:
a light guide plate main body including a first surface on which a light output from a light source section is made incident, a second surface adjacent to the first surface, a third surface which faces the first surface, and is adjacent to the second surface, and a fourth surface which faces the second surface, and is adjacent to the third surface;
a diffraction grating section arranged on the second surface;
wherein:
the diffraction grating section is configured in such a way that a plurality of gratings consisting of a dielectric is arranged in parallel at an interval Λ along a predetermined direction facing from the first surface to the third surface; wherein
when a wavelength of a visible region possessed by the light is set to be λ, the interval Λ satisfies 1≧Λ/λ0.5; and wherein
when a refraction index of the light guide plate main body is set to be nₛ, and a refraction index of the grating is set to be n_{g}, the refraction index n_{g} satisfies n_{g}-nₛ≧0.15.

2. A light guide plate according to claim 1, wherein the diffraction grating section includes a plurality of diffraction regions in which light extraction efficiency from the diffraction grating section is different along the predetermined direction, wherein,
the extraction efficiency of a plurality of the diffraction regions becomes high at the third surface side in the predetermined direction.

3. A light guide plate according to claim 1, wherein a polarization converting element which is arranged on the third surface of the light guide plate main body, and reflects the light to the first surface side by converting the polarization state of the light is further comprised.

4. A light guide plate according to claim 1, wherein a reflector reflecting the light is provided on the fourth surface of the light guide plate main body.

5. A surface light source device comprising:
a light source section outputting a light including the visible region;
a light guide plate main body having a first surface on which the light output from the light source section is made incident, a second surface adjacent to the first surface, a third surface which faces the first surface, and is adjacent to the second surface, and a fourth surface which faces the second surface, and is adjacent to the third surface;
a light guide plate including a diffraction grating section arranged on the second surface wherein;
the diffraction grating section is configured in such a way that a plurality of gratings consisting of a dielectric is arranged in parallel at an interval Λ along a predetermined direction facing from the first surface to the third surface wherein;
when a wavelength of the visible region possessed by the light is set to be λ, the interval Λ satisfies 1≧Λ/λv0.5; and wherein
when a refraction index of the light guide plate main body is set to be nₛ, and a refraction index of the grating is set to be n_{g}, the refraction index n_{g} satisfies n_{g}-nₛ≧0.15.

6. A surface light source device according to claim 5, wherein the diffraction grating section has a plurality of diffraction regions in which light extraction efficiency from the diffraction grating section is different along the predetermined direction, wherein;
the extraction efficiency of a plurality of the diffraction regions becomes high at a third surface side in the predetermined direction.

7. A surface light source device according to claim 6, wherein a polarization converting element which is arranged on a side of the third surface, and reflects the light to the first surface side by converting the polarization state of the light output from the third surface is further comprised.

8. A surface light source device according to claim 5, wherein a reflector which is arranged at an opposite side of the second surface side with respect to the fourth surface, and reflects the light to the second surface side is further comprised.

9. A liquid crystal display device comprising:
a surface light source;
a liquid crystal display section on which the light output from the surface light source device is made incident wherein;
the surface light source including:
a light source section outputting the light having the visible region;
a light guide plate main body having a first surface on which the light output from the light source section is made incident, a second surface adjacent to the first surface, a third surface which faces the first surface, and is adjacent to the second surface, and a fourth surface which faces the second surface, and is adjacent to the third surface;
a light guide plate having a diffraction grating section arranged on the second surface and wherein;
the diffraction grating section is configured in such a way that a plurality of gratings consisting of a dielectric is arranged in parallel at an interval Λ along a predetermined direction facing from the first surface to the third surface wherein;
when a wavelength of the visible region possessed by the light is set to be λ, the interval Λ satisfies 1≧Λ/λ0.5; and wherein
when a refraction index of the light guide plate main body is set to be nₛ, and a refraction index of the grating is set to be n_{g}, the refraction index n_{g} satisfies n_{g}-nₛ≧0.15.
